(19) United States
(12) Patent Application Publication
(10) Pub. No.: US 2023/0013606 A1
(43) Pub. Date: Jan. 19, 2023

(54) ROBOTIZED WALKER AND ASSOCIATED METHOD FOR PREVENTING FALLS

(71) Applicant: GEMA, IVRY SUR SEINE (FR)

(72) Inventor: Viviane Pasqui, Viroflay (FR)

(21) Appl. No.: 17/787,382

(22) PCT Filed: Dec. 21, 2020
(86) PCT No.: PCT/FR2020/052586

§ 371 Date: Jun. 20, 2022

(30) Foreign Application Priority Data
Dec. 20, 2019 (FR) FR1915381

(51) Int. Cl. A61H 3/04

(52) U.S. Cl. CPC A61H 3/04; A61H 2003/043; A61H 2201/1207; A61H 2201/5058; A61H 2201/1635; A61H 2201/5061; A61H 2201/0192; A61H 2003/046; A61H 2201/1659; A61H 2201/0176; A61H 2201/5092; A61H 2201/5007

(57) ABSTRACT

The invention relates to a robotic walker (1) including a chassis (10) having a front portion (10a), a rear portion (10b), wheels (11a, 11b, 12) arranged to support the rear portion (10b) and the front portion (10a) of the chassis (10), one of the wheels (11a, 11b, 12) being coupled to a displacement motor (20), the robotic walker (1) including a control module (40) configured to control the displacement motor (20), and to:
Determine an indicator of an involuntary movement of a user of the robotic walker (1) that could lead to a fall, based on values generated by one or several sensor(s);
Identify a previous position, at the given moment, of at least two wheels (11a, 11b, 12);
Transmit a command to stop the robotic walker (1);
Transmit a command to move the robotic walker (1) so that it returns to the previous position.

The invention concerns the field of walking assistance devices, and more particularly robotic walkers. The invention relates to a robotic walker arranged and configured to prevent the fall of a user as well as a method for preventing a fall of a user using said robotic walker.

### PRIOR ART

Many human beings are suffering from walking and balance disorders. These disorders have various origins and can affect people of all ages, but are frequent in the context of physiological aging. However, the aging world population is increasing rapidly and the percentage of older people is expected to increase from 10% in 2000 to 24% by 2030 (Shishehgar et al. A systematic review of research into how robotic technology can help older people. Smart Health. Volumes 7-8, June 2018, Pages 1-18). The care needs of the older people will therefore increase when they are already high, particularly in countries such as Japan, the United States, Canada, Australia and Europe.

The care of the person with walking and balance disorders is done in three parts: rehabilitation, arrangement of the living space and use of technical assistances. Technical walking assistances are for example: canes, walking frames, and walkers. Technical walking assistances allow a person with walking and/or balance disorders to regain some autonomy.

It has been proposed walkers capable of passively blocking the movement of a wheel when the position of the user is too advanced relative to a walking assistance device (CN107693316). Particularly, when the operator bears on part of the walker, his weight overcomes the force of a spring which in turn blocks the wheel or allows a braking element to gradually come into contact with the ground and to stop. Nevertheless, these attempts to improve the stability of walkers remain ineffective. Indeed, such arrangements do not meet the needs of users who face potentially very diverse situations so that the system can be triggered at the wrong time or worse is not triggered at all. Furthermore, these walkers can be difficult to use, as they generally require part of the chassis to be lifted to unlock the wheels.

It has also been proposed motorized walkers capable of determining the speed or the acceleration of the robotic walker and then initiating a braking when a limit value is exceeded (WO2009026119). Similarly, it has been proposed robotic walkers capable of measuring the pressure exerted on antebrachial bearings and of triggering a braking of the walking assistance device when pressure values are determined to be too high or too low (CN107109187).

These devices allow preventing some falls by blocking the robotic walker following the identification of a risk of falling based on different sensors. Nevertheless, stopping the walker is not an optimal way to prevent falls in the context of a user suffering from walking and balance disorders. Indeed, it is necessary to have a system which, in addition to reducing the immediate risk of falling, will be capable of rebalancing the user and reinforcing his autonomy such that the user who has just avoided a fall can resume his displacement with a reduced risk of falling.

### Technical Problem

The invention therefore aims to overcome the drawbacks of the prior art. Particularly, the invention also aims to propose a robotic walker arranged so as to prevent a user from falling and more generally to reduce the risk of falling, and this preferably while providing him with monitoring means configured to control the displacement of the walker intuitively. The invention furthermore aims to propose a method for preventing a fall of a user from a robotic walker.

### BRIEF DESCRIPTION OF THE INVENTION

To this end, the invention relates to a robotic walker including a chassis having a front portion and a rear portion, a pair of wheels being arranged to support the rear portion of the chassis, and at least one wheel being arranged to support the front portion of the chassis,
at least one of the wheels being coupled to a displacement motor, said robotic walker including a control module configured so as to be able to control the displacement motor(s), said robotic walker being characterized in that the control module is configured to:
   Determine, at a given moment, an indicator of an involuntary movement of a user of the robotic walker that could lead to a fall of said user preferably, the indicator of an involuntary movement of a user of the robotic walker being determined based on values generated by one or several sensors selected among: a sensor integrated into an electronic handle, a sensor configured to measure the displacement of a wheel, a distance sensor configured to measure the distance between the user and the robotic walker or a sensor positioned on the user of the robotic walker;
   Identify a previous position, at the given moment, of at least one of the wheels, preferably at least two wheels;
   Transmit to the displacement motor a command to stop the robotic walker, preferably for a predetermined stop duration; and
   Transmit to the displacement motor a command to move the robotic walker so that it finds the previous position at the identified given moment.

Thus, such a robotic walker prevents any risk for the user to fall or lose his balance. By identifying an involuntary movement of the user, which may be manifested in particular by gripping difficulties, physical difficulties of moving or even physical injuries affecting the notion of balance in a person in rehabilitation or in the older people, the robotic walker advantageously allows for compensation and even allows helping the user with such physical difficulties. Indeed, unlike known walkers, a walker in accordance with the invention allows on the one hand reducing the risk of falling by transmitting a stop command to the displacement motor, thus allowing the user to use the robotic walker to avoid the fall without the latter moving in an inappropriate direction, and, on the other hand, compensating for the user's loss of balance by allowing the wheels of said robotic walker to return to their previous or initial position, that is to say before the detection of the involuntary movement. Advantageously, the decision to return to a previous position is made faster than the human reflex, that is to say preferably in less than 50 ms.

Thus, the robotic walker according to the invention is arranged and configured to compensate for a displacement with a risk of falling but also to reposition the user in his initial position before the detection of the loss of balance (i.e. involuntary movement) and this without destabilizing him.

According to other optional characteristics of the robotic walker, it may optionally include one or several of the following characteristics, alone or in combination:
the command to move the robotic walker includes a predetermined duration of return to the previous position at the identified given moment (i.e. moment of the measurement of the involuntary movement) allowing the control module to determine a speed of displacement of the wheels. This allows applying a more or less rapid speed to the return of the wheels to position and therefore to the rebalancing of the user. Depending on the users, this speed can be configured to be more or less fast so as to provide maximum comfort for everyone. As will be detailed below, this predetermined duration of return to the previous position can be determined by supervised or unsupervised learning.
the command to stop the robotic walker includes a predetermined immobilization duration allowing the control module to determine a speed of displacement of the wheels before they stop. This allows applying a more or less rapid speed to the blocking of the wheels. Depending on the loss of balance situation, it will be preferable to apply a sudden stop or a gradual stop.
the previous position at the given moment corresponds to the position of the wheel(s) at least ten milliseconds before the given moment. This allows restoring the position of the wheels of the robotic walker to a position preceding the position of the walker upon detection of the loss of balance and thus helping the user to regain balance.
the indicator of an involuntary movement of a user of the robotic walker is determined based on values generated by one or several sensor(s) selected among: a sensor integrated into an electronic handle, a sensor configured to measure the displacement of a wheel, a distance sensor configured to measure the distance between the user and the robotic walker or a sensor positioned on the user of the robotic walker. The use of one or several sensors allows securing the user and detecting a plurality of imminent falls and in particular multiplying the cases of falls that can be taken into consideration by the robotic walker.
the indicator of an involuntary movement of a user of the robotic walker is determined based on values generated by a sensor integrated into an electronic handle and a distance sensor configured to measure the distance between the user and the robotic walker.
the indicator of an involuntary movement of a user of the robotic walker is determined over a predetermined time interval. Indeed, it is possible to determine the risks of falling based on values measured instantly, but the measurement of an evolution over several consecutive measurements allows for greater sensitivity and better adaptation to the different users.
the indicator of an involuntary movement of a user of the robotic walker is determined over a time interval comprised between 0.01 ms and 50 ms, preferably between 1 ms and 50 ms, more preferably between 5 ms and 40 ms and even more preferably between 8 ms and 20 ms. Such a duration advantageously allows quickly detecting a risk of an imminent fall and stopping and correcting the trajectory of the robotic walker in order to compensate for and avoid the fall of the user.
the indicator of an involuntary movement of a user of the robotic walker is determined from a comparison between a calculated value of the variation in the speed of at least one wheel and a threshold value of the variation in the speed of at least one wheel. This advantageously allows defining a speed variation limit adapted to the physical condition and to the needs of the user, beyond which a loss of control of the robotic walker by the user, in particular related to an imminent fall, can be characterized.
the robotic walker includes at least one electronic handle including a sensor operatively coupled to a control module, said sensor being configured to determine a force of interaction between a hand of the user and the robotic walker and the indicator of an involuntary movement is determined from said force of interaction. Particularly, the indicator of an involuntary movement corresponds to a value calculated from the force of interaction between a hand of the user and the robotic walker such as a calculated value of the variation in the force of interaction between the hands of the user and the robotic walker. This advantageously allows defining an interval of force applied outside of which the user is considered to be in a position of loss of balance, a force applied too high, on either of the electronic handles, can thus characterize a loss of balance of the user.
the robotic walker includes at least one sensor integrated into an electronic handle configured to allow the determination of a value of the force of interaction between a hand of the user and the robotic walker, and in that the control module is further configured to identify the indicator of an involuntary movement of a user of the robotic walker that could lead to a fall of said user, based on the determined value of the force of interaction, preferably when the determined force value is greater than a predetermined threshold value. The control module can also be configured to identify the indicator of an involuntary movement of a user of the robotic walker that could lead to a fall of said user when the determined value of the force of interaction is not comprised between predetermined bounds. The determined value of the force of interaction can be advantageously used in combination with other measured or calculated values. The use of a determined value of the force of interaction allows determining more accurately whether a fall is probable. Preferably, the control module can further be configured to identify the indicator of an involuntary movement of a user of the robotic walker that could lead to a fall of said user based on the determined value of the force of interaction and on another measured value such as for example a value of the distance between the user and the robotic walker. Such a combination is particularly advantageous and, for example, more efficient than measuring the displacement of a wheel.
It includes at least one distance sensor configured to measure a value of the distance between the user and the robotic walker and the control module is further configured to identify the indicator of an involuntary movement of a user of the robotic walker that could lead to a fall of said user based on the distance value, preferably when the measured distance value is not comprised between predetermined bounds. This advantageously allows defining a distance interval, a distance, or a distance variation outside which the user is considered to be in a position of loss of balance, a too high distance will not allow the user to bear on the robotic walker and can be considered as a forward or backward fall.
it further includes a data memory, coupled to the control module, configured to store a predetermined value of the force multiplier coefficient and a predetermined value of the walking assistance adjustment coefficient, two electronic handles each including at least one sensor operatively coupled to the control module, said sensor being configured to generate data of the force of interaction between a hand of the user and the robotic walker, at least one displacement sensor configured to measure data of displacement of the walking assistance robotic walker, the control module being further configured to:
   Determine a value of the force of interaction between a hand of the user and the robotic walker for each of the electronic handles based on the data generated by each of the sensors of the electronic handles;
   Determine a value of the speed of displacement of the robotic walker based on measured displacement data;
   Calculate, for each of the motorized wheels, an increment value based on:
      values of the force of interaction between a hand of the user and the robotic walker corrected with the predetermined value of the force multiplier coefficient, and
      the value of the speed of displacement of the robotic walker corrected by the predetermined value of the walking assistance adjustment coefficient.
the electronic handle is arranged so as to allow the measurement of at least two components of a force being applied thereto, said electronic handle comprising:
   a first photoelectric cell, said first photoelectric cell including a first diode able to emit a light beam and a first receiver arranged to receive said light beam, said first photoelectric cell being configured to generate a current proportional to an amount of photons received by the first receiver, and
   a first obturation element capable, depending on its position relative to the first photoelectric cell, of modifying the amount of photons received by the first receiver,
   the first photoelectric cell and the first obturation element being arranged such that the force applied to the electronic handle is able to cause a modification of the amount of photons received by the first receiver, said modification being proportional to a first component of the force that has been applied to the electronic handle.
   a second photoelectric cell including a second diode able to emit a light beam and a second receiver arranged to receive said light beam, said second photoelectric cell being configured to generate a current proportional to an amount of photons received by the second receiver,
   a second obturation element capable, depending on its position relative to the second photoelectric cell, of modifying the amount of photons received by the second receiver,
   the second photoelectric cell and the second obturation element being arranged such that the force applied to the electronic handle is able to cause a modification of the amount of photons received by the second receiver, said modification being proportional to a second component of the force that has been applied to the electronic handle, said electronic handle being configured to control said motor based on the values of the two calculated force components.
   the electronic handle includes a central part and an external casing, the electronic handle is arranged such that a force, adapted to the command of the walking assistance apparatus, applied to the electronic handle, is able to move at least partly the central part or the external casing, preferably able to move at least partly the central part. Such an arrangement allows simply following the application of a force on the electronic handle.
   the first photoelectric cell and/or the first obturation element and the second photoelectric cell and/or the second obturation element are fixed on the central part. Such an arrangement allows simply following the application of a force on the electronic handle.
   the central part comprises at least one embedded beam comprising an embedded end and a free end, said free end having a degree of mobility authorizing a displacement of said free end along the direction of the second component of the applied force. Such an arrangement allows simply following the application of a force on the electronic handle.

The invention further relates to a system for monitoring the displacement of a walker comprising:
a robotic walker according to the invention, said robotic walker further comprising a beacon associated with the walker,
at least one independent beacon configured to reflect or emit a signal, the robotic walker being configured to actuate the braking when the distance between the beacon associated with the walker and the independent beacon is less than a predetermined threshold value.

Such a system advantageously allows preventing the user of the walker from approaching an area including a beacon (i.e. an independent beacon) and thus allows limiting access to this area. The beacon associated with the walker can for example be a beacon transmitter and in this case the independent beacon is a beacon receiver capable of reflecting the signal emitted by the beacon associated with the walker, and vice versa.

The invention further relates to a method for preventing a fall of a user from a robotic walker, said prevention method including the following steps implemented by a control module:
determining, at a given moment, an indicator of an involuntary movement of a user of the robotic walker that could lead to a fall of said user;
identifying a previous position, at the given moment, of at least one of the wheels, preferably at least two wheels;
transmitting to the displacement motor an instruction to immobilize the robotic walker, preferably for a predetermined stop duration; and
transmitting to the displacement motor an instruction to move the robotic walker so that it finds the previous position, at the identified given moment, of the at least one of the wheels.

Such a method for preventing a fall of a user allows, based on the identification of a risk of falling, repositioning the robotic walker so that it finds a previous position upon identification of a risk of falling. Thus, in one measuring and processing step, the method can identify a risk of falling and a safety position and prevent the fall while putting the walker back in a position that allows rebalancing the user.

Other implementations of this aspect comprise computer systems, apparatuses, and corresponding computer programs stored on one or several computer storage devices, each being configured to perform the actions of a method according to the invention. Particularly, a system of one or several computers can be configured to perform particular operations or actions, in particular a method according to the invention, thanks to the installation of software, firmware, hardware or a combination of software, firmware or hardware installed on the system.

Furthermore, one or several computer programs can be configured to perform particular operations or actions through instructions which, when executed by a data processing apparatus, cause the apparatus to perform the actions.

Other advantages and characteristics of the invention will appear upon reading the following description given by way of illustrative and non-limiting example, with reference to the appended Figures:

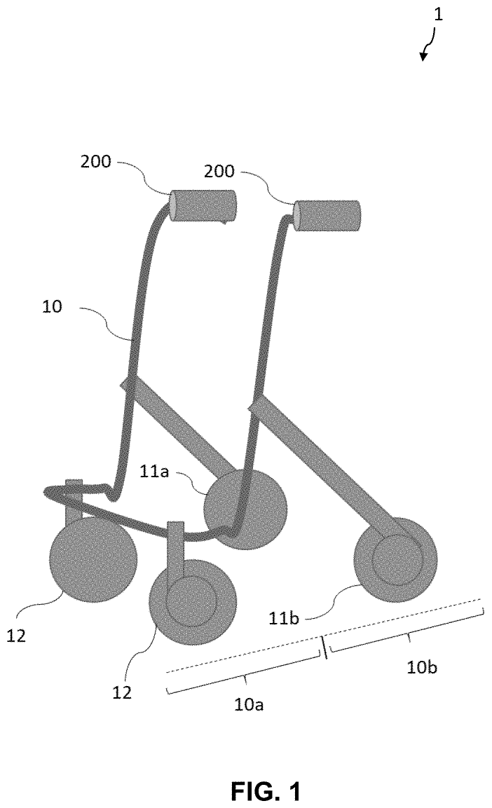

FIG. 1 represents an illustration of a perspective view of a robotic walker according to one embodiment of the invention.

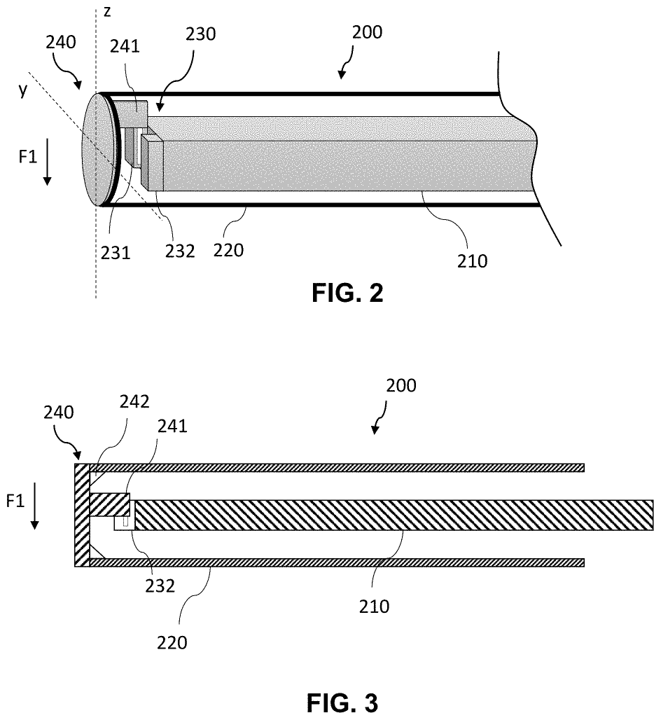

FIG. 2 represents an illustration of a perspective view of an electronic handle according to one embodiment of the invention, the external casing having been made transparent so as to allow visualization of the inside of the handle.

FIG. 3 represents an illustration of a side view of a longitudinal section along an axis z of a handle according to one embodiment of the invention.

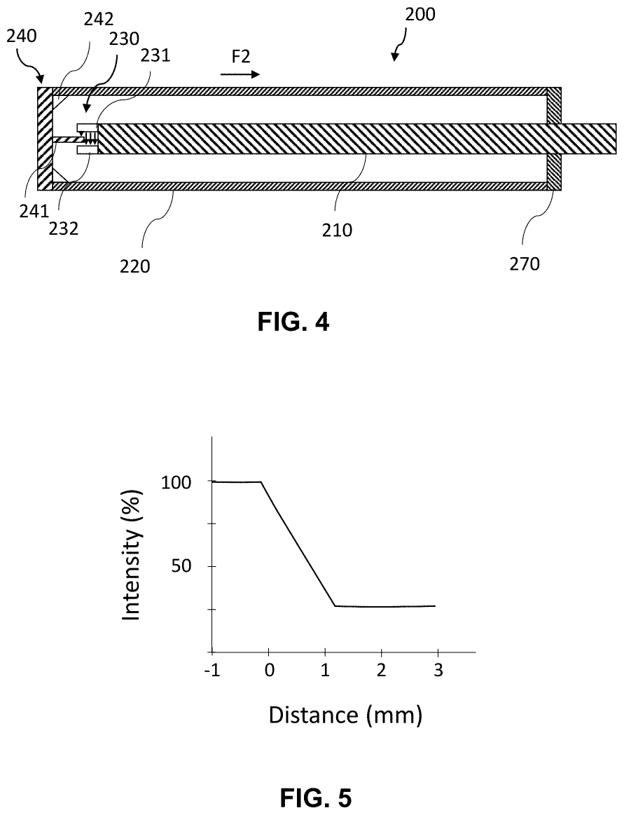

FIG. 4 represents an illustration of a top view of a longitudinal section along an axis y of a handle according to one embodiment of the invention.

FIG. 5 represents a curve of light intensity received by the receiver of a photoelectric cell as a function of the displacement of an obturation element.

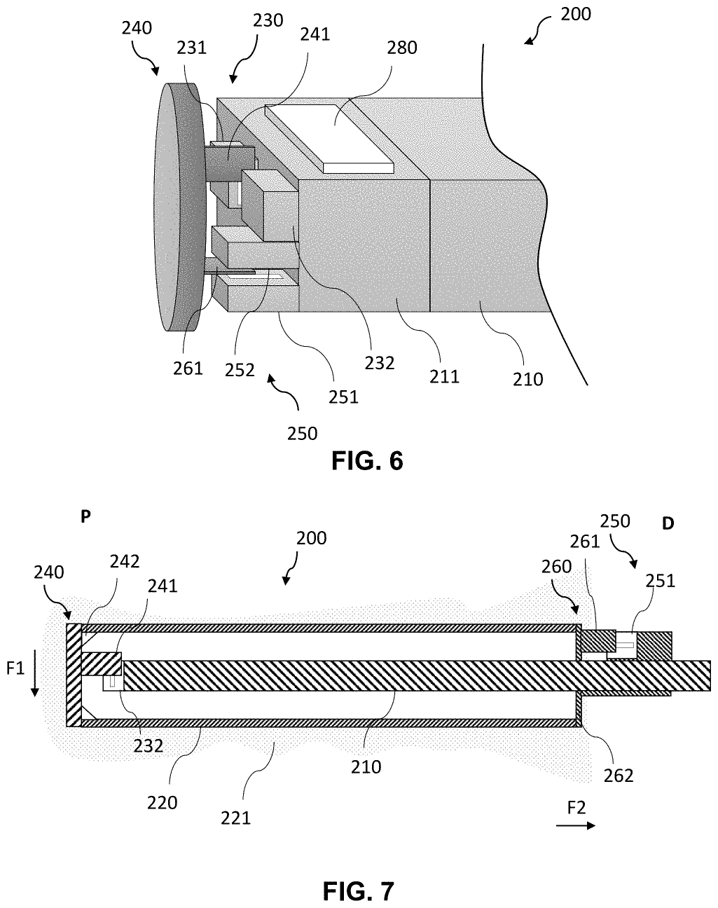

FIG. 6 represents an illustration of a perspective view of a handle according to one embodiment of the invention. The external casing has been omitted.

FIG. 7 represents an illustration of a side view of a longitudinal section along an axis z of a handle according to one embodiment of the invention.

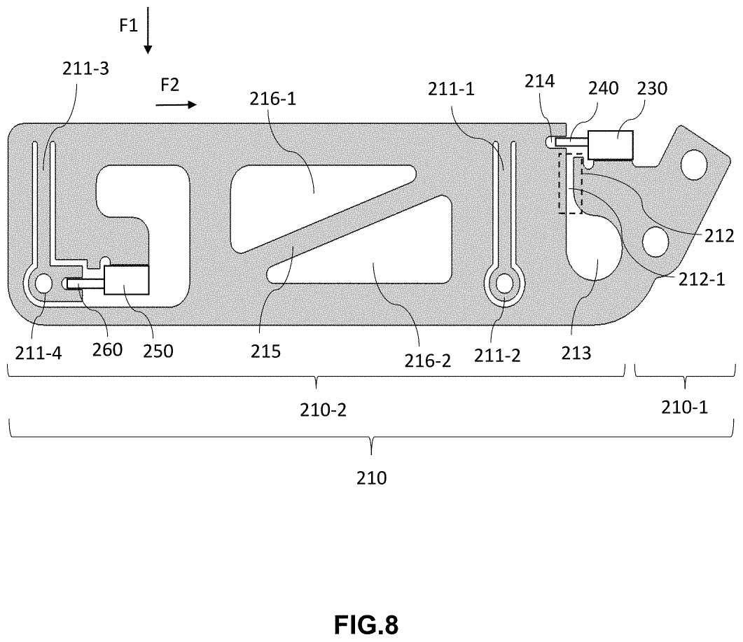

FIG. 8 represents an illustration of a front view of the central part of a handle according to the invention.

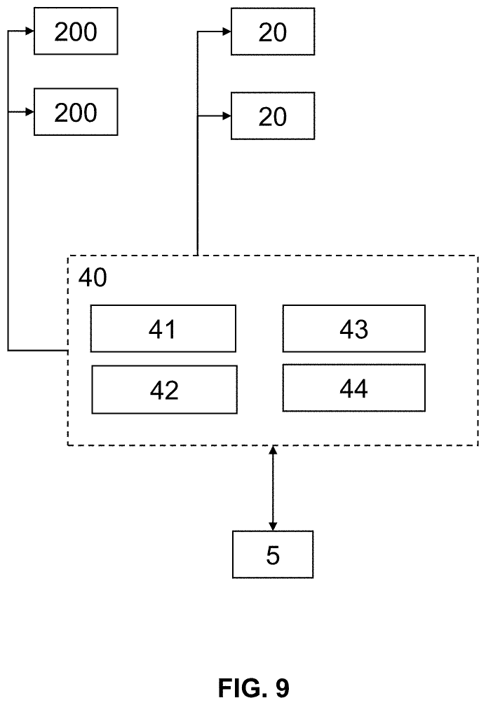

FIG. 9 represents a block diagram of the motors and control members of a robotic walker according to one embodiment of the invention.

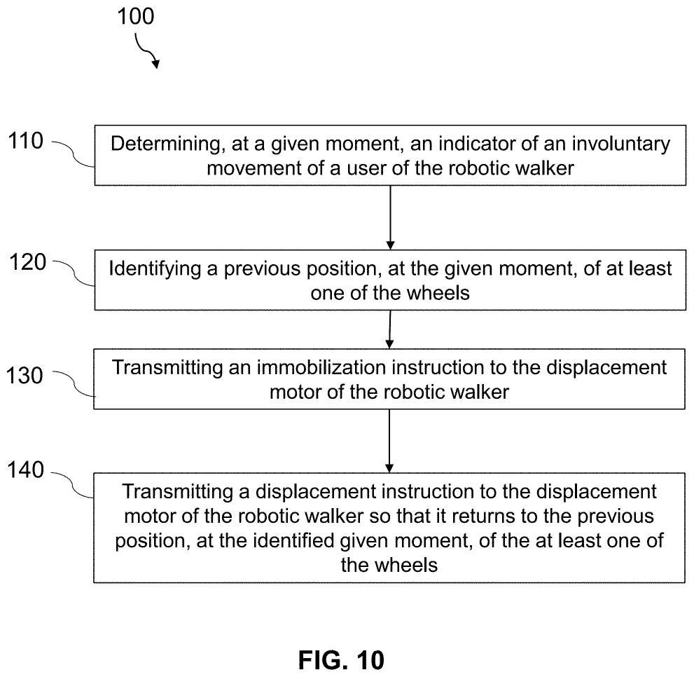

FIG. 10 represents an illustrative diagram of a method for preventing a fall by a user from a robotic walker in accordance with the invention.

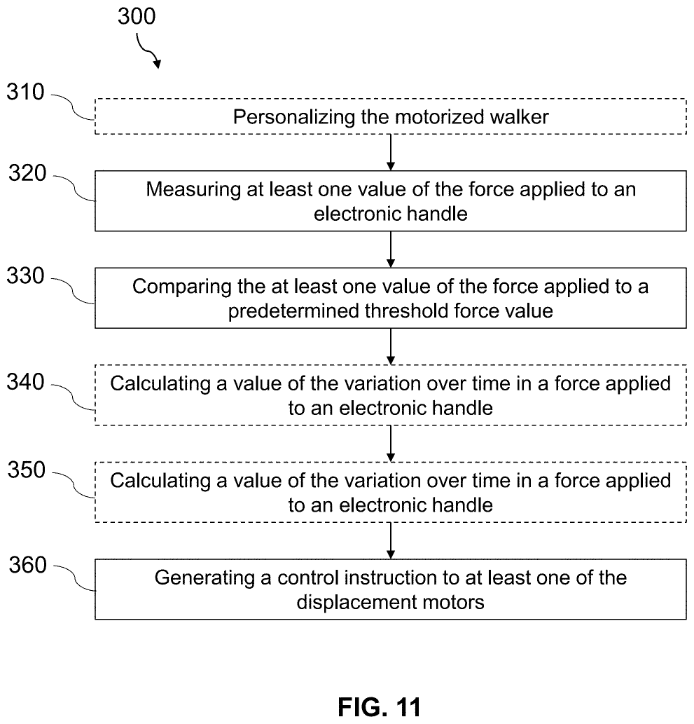

FIG. 11 represents an illustrative diagram of steps of a method for controlling a robotic walker according to the invention. Steps framed in dotted lines are optional.

Aspects of the present invention are described with reference to flowcharts and/or block diagrams of methods or apparatuses (systems) according to embodiments of the invention.

In the figures, the flowcharts and the block diagrams illustrate the architecture, the functionality, and the operation of possible implementations of systems and methods according to various embodiments of the present invention. In this regard, each block in the flowcharts or block diagrams can represent a system, a device, a module, or a code, which comprises one or several executable instructions to implement the specified logical function(s).

### DESCRIPTION OF THE INVENTION

In the remainder of the description, the term “walker” corresponds to a walking assistance device including at least three wheels and preferably four wheels. It can for example be named rollator.

The expressions “front portion” and “rear portion” can be defined as all the elements of the robotic walker located respectively on either side of a longitudinal section plane of a front view of the robotic walker, said longitudinal section plane passing through the center of gravity of said robotic walker. The rear portion being the portion intended to accommodate a user.

In the remainder of the description, the expression “electronic handle” corresponds for example to a device that allows supporting the weight of a user, arranged to accommodate a hand of said user and comprising within it one or several sensors arranged so as to allow a measurement of a force.

The term “Force” within the meaning of the invention corresponds to a mechanical action exerted by a user on a surface and particularly on the electronic handle. Thus, an “applied force” corresponds within the meaning of the invention to a user exerting a pressure on the external surface of said electronic handle.

The expression “component of a force” corresponds to a projection of a force on one direction. A “first component” thus corresponds for example to a projection of a force along an axis Z represented by an ascending vertical axis and orthogonal to the longitudinal axis of the electronic handle. A “second component” thus corresponds to a projection of a force along an axis X, corresponding to the longitudinal axis of the electronic handle.

The term “fixed” corresponds to the securing of two distinct entities to each other. Thus, two entities can have a removable or non-removable fixing.

The term “removable” corresponds according to the invention to the ability to be easily detached, removed or dismounted without having to destroy fixing means either because there is no fixing means or because the fixing means are easily and quickly dismountable (e.g. notch, screw, tab, lug, clips). For example, by removable, it should be understood that the object is not fixed by welding or by any other means not intended to allow the object to be detached.

A “non-removable” or “irremovable” fixing corresponds according to the invention to the ability to not be detached, removed or dismounted without having to destroy fixing means either because there is no fixing means or because the fixing means are not easily and quickly dismountable. For example, by non-removable, it should be understood that the object is fixed by welding or more generally by any irreversible securing means.

The term “tubular” corresponds to a substantially elongate element forming a duct whose light is enclosed by a wall of said duct. Such a light thus designates a hollow interior space circumscribed by the wall of the duct.

When the term “substantially” is associated with a particular value, it should be understood as a value varying by less than 30% with respect to the compared value, preferably by less than 20%, even more preferably by less than 10%. When “substantially identical” is used to compare shapes then the vectorized shape varies by less than 30% relative to the compared vectorized shape, preferably by less than 20%, even more preferably by less than 10%.

It is meant by “polymer” either a copolymer or a homopolymer. A “copolymer” is a polymer grouping together several different monomer units and a “homopolymer” is a polymer grouping together identical monomer units. A polymer can for example be a thermoplastic or thermosetting polymer.

It is meant by “thermoplastic polymer” or “thermoplastic” a polymer which can be repeatedly softened or melted under the action of heat and which adopts new shapes by the application of heat and pressure. Examples of thermoplastics are, for example: high density polyethylene (HDPE), polyethylene terephthalate (PET), polyvinyl chloride (PVC), polystyrene (PS) or acrylonitrile butadiene styrene (ABS).

It is meant by “thermosetting polymer” a plastic material which is transformed irreversibly by polymerization into an insoluble polymer network. Once the shape of the thermosetting polymer has been set and cooled, it cannot be changed by the action of heat. Thermosetting polymers are for example: unsaturated polyesters, polyamides, polyurethanes or vinyl esters which can be epoxy or phenolic.

It is meant by “coupled” within the meaning of the invention connected, directly or indirectly, with one or several intermediate elements. Two elements can be mechanically, electrically coupled or linked by a communication channel.

The term “learning” within the meaning of the invention corresponds to a method designed to define a function f that allows calculating a value of Y from a base of n labeled (X1 . . . n, Y1 . . . n) or unlabeled (X1 . . . n) observations. Such a function can correspond to a prediction model. The learning can be said to be supervised when it is based on labeled observations and unsupervised when it is based on unlabeled observations. In the context of the present invention, the learning is advantageously used to personalize the operation of the walker and therefore its adaptation to a particular user. Preferably, the learning may correspond to the learning of a model capable of predicting a time series.

It is meant by “prediction model” any mathematical model that allows analyzing a volume of data and establishing relationships between factors allowing the assessment of risks or of opportunities associated with a specific set of conditions, in order to orient the decision-making towards a specific action.

It is meant by “process”, “calculate”, “execute”, “determine”, “display”, “extract”, “compare” or more broadly “executable operation”, within the meaning of the invention, an action performed by a device or a processor unless the context indicates otherwise. In this regard, the operations refer to actions and/or processes of a data processing system, for example a computer system or an electronic computing device, which manipulates and transforms the data represented as physical (electronic) quantities in the memories of the computer system or other information storage, transmission or display devices. These operations can be based on applications or software.

The terms or expressions “application”, “software”, “program code”, and “executable code” mean any expression, code or notation, of a set of instructions intended to cause a data processing to perform a particular function directly or indirectly (e.g. after an operation of conversion towards another code). The program code examples can include, but are not limited to, a subroutine, a function, an executable application, a source code, an object code, a library, and/or any other sequence of instructions designed for the execution on a computer system.

Within the meaning of the invention, the term “processor” designates at least one hardware circuit configured to execute instructions contained in the program code. The hardware electronic circuit can be an integrated circuit. Examples of a processor comprise, but are not limited to, a central processing unit (CPU), a network processor, a vector processor, a digital signal processor (DSP), a field-programmable grid array (FPGA), a programmable logic assembly (PLA), an application-specific integrated circuit (ASIC), a programmable logic circuit and a controller.

The expression “man-machine interface” within the meaning of the invention corresponds to any element allowing a human being to communicate with an electronic device or the robotic walker to inform the user.

It is meant by “motorized” within the meaning of the invention, an apparatus or device equipped with any known suitable means (e.g. motor) that allows generating a displacement of all or part of the device with which said means is associated.

The term “robotic” within the meaning of the invention means an apparatus or device equipped with any known suitable means (e.g. motor) that allows generating a displacement of all or part of the device with which said means is associated, said displacement being controlled by means of an automatic control system. Particularly, a robotic walker corresponds to a walker whose motor piloting adapts to the environment based on the sensor data.

In the remainder of the description, the same references are used to designate the same elements.

Although walking assistance apparatuses such as robotic walkers are designed for people with reduced mobility, their use can sometimes cause the user to fall. Indeed, people with reduced mobility can also have balance disorders. As presented, there are robotic walkers configured to stop all movement when a risky situation is identified. However, such robotic walkers cause use discomfort and may not be able to prevent some falls.

The inventor has determined that, in addition to stopping the walker, preventing the fall will be more effective in the presence of a rebalancing of the user in his initial position before the occurrence of the event that could lead to a fall and this without destabilizing it.

The present invention therefore proposes a robotic walker including a control module 40 configured to directly or indirectly monitor the wheels of the walker so as to allow fall prevention and configured to prevent a fall by blocking the wheels and engaging a return to a previous position.

Thus, according to a first aspect, the invention relates to a robotic walker 1. Particularly, and as illustrated in FIG. 1, such a robotic walker 1 includes a chassis 10 having a front portion 10a and a rear portion 10b.

The chassis 10 can be made of metal, metal alloy, polymer, a composite assembly or a mixture of these materials. Preferably, the chassis 10 is made of stainless steel, aluminum or both. In addition, the chassis 10 can be covered with a shell. Such a shell can be made of polymers, composites or any other materials.

A robotic walker 1 according to the invention includes a pair of wheels 11a, 11b arranged to support the rear portion 10b of the chassis 10, and at least one wheel 12 which is arranged to support the front portion 10a of the chassis. As illustrated in FIG. 1, the chassis preferably includes two wheels at the rear and two wheels at the front.

Preferably, the robotic walker 1 will include motorized wheels arranged to support the rear portion 10b of the chassis 10. For example, the only motorized wheels can be those supporting the rear portion 10b of the chassis 10.

Indeed, the walker 1 according to the invention is a robotic walker. Thus, at least one of these wheels is coupled to a displacement motor 20, described in relation to the functional diagram presented in FIG. 8. Such a displacement motor 20 is disposed at the level of a wheel and is not directly visible in FIG. 1. The displacement motor 20 is hidden by a shell positioned at the level of one or several wheels. Thus, several wheels can each be connected to a displacement motor 20. Any type of electric motor can be used such as servomotors, stepper motors and DC motors, preferably a brushless motor such as a brushless electronically-commutated motor. A speed reducer can be integrated into the motors.

In addition, the displacement motor(s) 20 can also serve as brakes. That is to say, in one embodiment, the displacement motors 20 may serve as drive units to drive the rear wheels 11a, 11b and brake units to brake the rear wheels 11a, 11b. Particularly, the displacement motors 20 can be used to brake the rear wheels 11a, 11b.

Alternatively, it is also possible that the displacement motors 20 only serve as drive units for driving the rear wheels 11a, 11b and that brake units intended to brake the rear wheels 11a, 11b are provided separately from the displacement motors 20. These braking units can for example be electromagnetic brakes or mechanical brakes.

Advantageously, each of the rear wheels 11a, 11b includes a displacement motor 20 coupled thereto to assist the movement of each of the rear wheels 11a, 11b which corresponds thereto.

In one embodiment, the displacement motors 20 can be installed in the rear wheels 11a, 11b, but it is also possible that only the front wheel(s) 12 include displacement motors 20 or alternatively that all the front 12 and rear 11a, 11b wheels include displacement motors 20 installed inside.

A robotic walker 1 according to the invention further includes a control module 40. Particularly, the control module 40 can include one or several processors 41. The control module 40 can control the entire robotic walker 1, including the displacement motors 20.

The control module 40 can advantageously be configured to cooperate with the sensors, collect the data measured by said sensors and calculate one or several values from said measured data. Such cooperation can in particular take the form of an internal communication bus.

The control module 40 can be provided adjacent to a battery 21. The command by the control module 40 will be described later.

Furthermore, the control module 40 can include or be coupled to a data memory 42. The data memory 42 may advantageously include a non-erasable section, physically isolated or simply arranged so that a write or erase access is prohibited. The data memory can furthermore be arranged to record the data measured by the sensors present on a robotic walker and/or on the user of the robotic walker. The data memory 42 can further comprise one or several programs, or more generally one or several sets of program instructions, said program instructions being intelligible by the processor 41. The execution or the interpretation of said instructions by said processor causes the implementation of a method for preventing the fall of a user from a robotic walker 1 according to the invention.

The data memory 42 is advantageously configured to store threshold values that can be used during the monitoring of the robotic walker 1 by a processor 41 or more generally by a control module 40.

For example, as will be detailed later, the data memory 42 is configured to store a predetermined stop duration and the positions of at least one of the wheels as a function of time. The stored values can correspond to values predetermined for example in the factory or during the first configuration of the walker. Advantageously, these values are derived from a correction as the user uses the walker through learning. In addition, other values can be set during the first use and then their automated correction with learning such as the force of detection of a hand on the handle, a resistance to walking in a straight line, a resistance to walking in turns, a force for which the speed remains constant in translation, a minimum forward force, a minimum distance between the user and the walker or a maximum distance between the user and the walker. In the context of the present invention, the distance between the user and the walker is used, in combination with a force value measured on a handle, and the threshold values of the minimum distance between the user and the walker or maximum distance between the user and the walker come from learning.

Particularly, the control module 40 is configured to determine an indicator of an involuntary movement of a user of the robotic walker 1 that could lead to a fall of said user.

Particularly, the determination of an indicator of an involuntary movement of a user of the robotic walker 1 corresponds to the identification of a loss of balance or preferably the beginnings of a loss of balance of the user of the walker.

This determination is for example based on a monitoring of the values generated by one or several sensors. This monitoring is preferably carried out continuously. The continuous monitoring corresponds for example to measurements carried out at a frequency of less than 80 ms, preferably less than or equal to 50 ms, more preferably less than or equal to 30 ms, for example less than or equal to 10 ms.

This monitoring is preferably carried out in real time from the values generated by one or several sensors. Particularly, starting from the measurement of values of the sensors, a method according to the invention is preferably configured to identify, where applicable, an indicator of involuntary movement within a period of less than 80 ms, preferably within a period of less than or equal to 50 ms, more preferably less than or equal to 20 ms, even more preferably less than or equal to 10 ms. Thus, a method according to the invention is configured to predict a risk of falling before its occurrence and as close as possible to the occurrence of the triggering element. There is also advantageously an action which occurs before the natural reaction of the user.

Thus, the control module 40 is configured to carry out a continuous and real-time analysis of sensor values so as to identify an involuntary movement that could lead to a fall.

Preferably, the indicator of an involuntary movement of a user of the robotic walker 1 is determined for a given moment.

Particularly, the indicator of an involuntary movement of a user of the walker is determined from values generated by one or several sensors selected among:
a sensor configured to measure the displacement of at least one wheel 11a, 11b, 12, preferably of at least two wheels,
a sensor configured to measure the displacement of the robotic walker,
a sensor integrated into an electronic handle 200, a sensor configured to analyze the instantaneous position of the user relative to the robotic walker (camera),
a distance sensor, and/or
a sensor positioned on the user of the robotic walker.

Thus, the coupling between the control module 40 and the sensor(s) equipping a robotic walker 1 according to the invention or a user allows synchronized access and real-time analysis of the measurements made by the sensor(s), by the control module 40. Thus, a robotic walker 1 in accordance with the invention allows continuous and automated analysis of the measurements made by the sensor(s) and allows preventing any risk of falling during its use by a user.

As just discussed, the indicator of an involuntary movement of a user can be determined from a multitude of sensors. Furthermore, this indicator can be identified from several transformations of the data coming from these sensors. Indeed, it is possible to base the determination of the indicator of an involuntary movement of a user on the comparison of an absolute value measured with a predetermined threshold value or on the comparison of a variation calculated over a predetermined time interval with a predetermined threshold variation value.

Preferably, the indicator of an involuntary movement of a user of the walker is determined over a predetermined time interval. For example, the indicator of an involuntary movement of a user of the walker can be determined over a time interval comprised between 0.01 ms and 80 ms, preferably comprised between 1 ms and 70 ms, more preferably comprised between 5 ms and 40 ms.

Furthermore, an indicator of an involuntary movement can be determined based on a calculation of an evolution over several consecutive measurements.

The comparison with thresholds may not allow optimal discrimination of the values currently measured and the values of sensor(s) reflecting a loss of balance. This is all the more true considering the strong heterogeneity of the affections of the users of the robotic walkers according to the invention. Thus, the inventor proposes the use of a learning that allows, for example, detecting normal values.

Preferably, the determination of an involuntary movement can then be adapted according to the users, for example based on a learning model. The control module can therefore be configured to implement a learning model. This allows for greater sensitivity and better adaptation to different users. Particularly, the robotic walker according to the invention can include a control module configured to carry out a learning step aimed at training a learning model for the analysis of the sensor data. Preferably, the learning will be done based on the sensor data so as to discriminate between sensor data corresponding to a current profile of the user and sensor data that may correspond to an abnormal situation, in this case the occurrence of an involuntary movement. The learning can be supervised or unsupervised.

According to the invention, the control module will be advantageously configured to execute a step of determining an involuntary movement indicator from a learning model. This step can include the implementation of a mathematical method that allows generating binary results, probability percentages of an involuntary movement indicator or any other value that allows identifying one or several involuntary movement indicators.

The step of determining an involuntary movement indicator from a learning model is preferably based on the prior construction of an unsupervised learning model which will be able to independently classify the value of a sensor data such as a currently measured value or an abnormal value. More preferably, the control module will be configured to execute a learning model based on a neural network, k-means partitioning or hierarchical clustering.

Sensor Configured to Measure the Displacement of a Wheel 11a, 11b, 12, Preferably at Least Two Wheels.

The displacement of a robotic walker is a good indicator that a fall is about to occur. A robotic walker 1 according to the invention can therefore include an angular sensor or speed sensor configured to detect the displacement of at least one wheel: the number of revolutions, the acceleration or the speed of at least one of the wheels and send signals representing the number of revolutions, the acceleration or the speed to the control module 40. The speed sensor can be disposed adjacent to the control module 40. It is also possible for the speed sensor to be installed at the level of the pair of rear wheels 11a, 11b of the robotic walker 1. Alternatively, it can also be possible for the speed sensor to be provided only in the front wheel(s) 12.

The speed sensor configured to detect the displacement of at least one wheel or angular position sensors can be selected among: incremental sensors, optical sensors, magnetic position sensors, mechanical sensors, for example of the gear type, or potentiometers.

If the displacement motors 20 are brushless motors, the speed sensor can calculate the number of revolutions or the speed of the wheels or the speed of the robotic walker 1 using a hall-effect sensor included in the displacement motors 20.

The speed can be detected from multiple values depending on the implemented technology: counter-electromotive force values, angular speed values, or acceleration component values. Thus, the indicator of an involuntary movement of a user of the walker can be determined from a comparison between a calculated value of the displacement of at least one wheel and a predetermined threshold value of the displacement of at least one wheel.

Furthermore, as mentioned, it is possible within the framework of the invention to be based on absolute values and/or on variations of values.

Thus, the indicator of an involuntary movement of a user of the walker can be determined from a comparison between a calculated absolute value of a speed of at least one wheel and a predetermined threshold absolute value of a speed of at least one wheel, the indicator then being preferably a calculated speed greater than a predetermined threshold speed. For example, the predetermined absolute threshold value of a wheel speed can be equal to 2 m·s⁻¹ (for meter per second).

However, the absolute values may not sufficiently represent the interaction of a user with the walker and may not be sufficiently sensitive to the risk of occurrence of a fall. Thus, preferably, the indicator of an involuntary movement of a user of the walker is determined from a comparison between a calculated value of the variation in the speed of at least one wheel and a threshold value of the variation in the speed of at least one wheel. For example, the threshold value of the variation in the speed of at least one wheel can be equal to 5 m·s⁻². Particularly, the calculated value of the variation in the speed of at least one wheel can correspond to an absolute value of the variation in the standard of the speed of the wheels for a duration comprised between 1 ms and 80 ms, preferably for a duration comprised between 5 ms and 70 ms and more preferably for a duration comprised between 10 ms and 60 ms.

Sensor Configured to Measure the Displacement of the Robotic Walker,

It was proposed above to measure the displacement of the walker based on the displacement of at least one wheel. Nevertheless, the displacement of the walker can also be determined based on physical measurement systems, video means (2Dimensions “2D” or 3Dimensions “3D” camera), ultrasound systems, an inertial unit, a laser rangefinder, a geolocation (Global Navigation Satellite System) or software measurement systems (Luenberger observers or Kalman filters).

Thus, a robotic walker 1 according to the invention can therefore include a 2D or 3D video means or an inertial unit configured to detect the displacement of the robotic walker 1.

The indicator of an involuntary movement of a user of the walker can then be determined from a comparison between a calculated value of the displacement of the walker and a predetermined threshold value of the displacement of the walker.

As previously, the indicator of an involuntary movement of a user of the walker can be determined from a comparison between a calculated absolute value of a speed and a predetermined threshold absolute value of a speed of the walker, the indicator then being preferably a calculated speed greater than a predetermined threshold speed.

Sensor Integrated with an Electronic Handle 200,

It has already been proposed in the literature to follow the existence or not of a gripping of a walker by its user to stop said walker. Indeed, the use of an electronic handle 200 capable of determining whether the user is holding the walker or not can be a good way of identifying a fall. Thus, a robotic walker 1 according to the invention can include at least one electronic handle 200 including a sensor operatively coupled to a control module 40.

The sensor integrated in the electronic handle 200 is for example selected among: a force sensor, a pressure sensor, a barrier photoelectric cell, a displacement sensor, and electrodes. In the context of the invention, it is proposed to go beyond a detection of presence of the hands on the handles of the robotic walker.

Thus, the sensor integrated into the electronic handle 200 is advantageously configured to allow the determination of a force of interaction between a hand of the user and the robotic walker. Thus, the indicator of an involuntary movement of a user of the walker can correspond to a calculated value of the force of interaction between the hands of the user and the robotic walker 1.

Preferably, the indicator of an involuntary movement of a user of the walker can correspond to a calculated value of the variation in the force of interaction between the hands of the user and the robotic walker 1. The value of the variation in the force of interaction between the hands of the user and the robotic walker 1 is preferably calculated over a time interval comprised between 0.1 ms and 80 ms, more preferably between 1 ms and 50 ms, even more preferably between 5 ms and 40 ms and for example between 5 ms and 20 ms.

For example, the indicator of an involuntary movement of a user of the walker could correspond to an absolute value of the variation in the standard of the force of interaction between the hands of the user and the robotic walker 1 for at least 10 ms is at least equal to 1,000 m·s⁻³. However, as already discussed, the variation will be preferably measured over a period of less than 80 ms.

Alternatively, the indicator of an involuntary movement of a user of the walker could correspond to a value of the force applied to the electronic handle 200.

For example, the indicator of an involuntary movement of a user of the walker could correspond to the overrun by a measured absolute value of the force of interaction between the hands of the user and the robotic walker 1 of a predetermined threshold absolute value of the force of interaction, for example equal to 100 N. Thus, if the absolute value of at least one hand-walker force of interaction is greater than 100 N then there is identification of an indicator of an involuntary movement.

Thus, the control module 40 is preferably configured to further calculate a value of the variation in the force applied to the electronic handle 200 over a time interval and determine an indicator of an involuntary movement when the calculated value of the variation in the force applied is greater than a predetermined threshold value of the force variation.

Indeed, during a loss of balance, the user will tend to hold on the electronic handles 200. The hands—handles force of interaction will then increase rapidly in the direction of the loss of balance.

Thus, when a threshold value has been predetermined and stored in the data memory 42 of the robotic walker 1, the control module 40 can be configured to actuate the braking, in particular by means of one or several displacement motors 20 serving as brakes or one or several braking unit(s) configured to perform the braking or the release of the braking of said robotic walker 1.

Advantageously, the braking can be activated when:
the absolute value of the variation in the force of interaction between the hands of the user and the robotic walker 1 for at least a predetermined duration is at least equal to the predetermined threshold absolute value of the force of interaction; and/or
the absolute value of at least one hand-handle force of interaction is at least equal to the predetermined threshold absolute value of the force of interaction; and/or
the absolute value of the variation in the distance measured between the user and the robotic walker 1 for at least a predetermined duration, for example 0.5 s, is at least equal to an absolute value of the variation in the threshold distance, for example 700 mm/s.

The braking can advantageously comprise several steps in order to avoid accentuating the loss of balance of the user and also to make him find a balance position:
The braking can induce immobilization of the wheels for a predetermined period,
The wheels return to their previous position, i.e. before the detection of an inappropriate distance (outside the predetermined bounds) between the user's trunk and the robotic walker 1.

Distance Sensor

A robotic walker 1 according to the invention can include a distance sensor.

The distance sensor can for example be selected among laser sensors, such as time-of-flight lasers, or ultrasound sensors or a camera, preferably a 3D camera.

The distance sensor is advantageously configured to measure a value of the distance between the trunk of a user of the walker and the chassis of the walker.

The distance sensor being generally fixed on the chassis 10 or to an element of the chassis, this allows measuring a value of the distance between a part of the body, preferably the trunk, of a user of the robotic walker 1 and the chassis 10. This allows detecting the relative position of the user relative to the walker.

Thus, alternatively, or additionally, the control module 40 can further be configured to determine the indicator of an involuntary movement of a user of the robotic walker 1 that could lead to a fall of said user when the measured distance value is not comprised between predetermined bounds.

The predetermined bounds can for example be stored in a data memory 42 of the control module 40. They can for example correspond to a distance comprised between 250 mm and 850 mm. Advantageously, these bounds are determined based on the height of the user of the robotic walker. In addition, preferably, they can be modified over the use of the walker by a learning mechanism.

When using a camera, in addition to the distance, the sensor can be configured to analyze the instantaneous position of the user relative to the robotic walker.

Furthermore, when bounds have been predetermined and stored in the data memory 42 of the robotic walker 1, the control module 40 can be configured to actuate the braking, in particular by means of one or several displacement motors 20 serving as brakes or one or several braking unit(s) configured to achieve the braking or the release of the braking of said robotic walker 1. Advantageously, the braking can be activated when the distance between the trunk of the user and the robotic walker 1 is less than greater than the minimum values, for example 250 mm, and maximum values, for example 850 mm, of the predetermined bounds.

The braking can advantageously comprise several steps in order to avoid accentuating the loss of balance of the user and also to return him to a balance position:
The braking can induce an immobilization of the wheels for a predetermined duration,
The wheels return to their previous position, i.e. before the detection of an inappropriate distance (outside the predetermined bounds) between the trunk of the user and the robotic walker 1.

Finally, when the user wishes to sit or bear on the robotic walker 1, he will necessarily release at least one electronic handle 200. From the moment the user releases one or both electronic handles 200, the sensor integrated into the corresponding electronic handle can indicate that no force of interaction between the user's hand and the electronic handle 200 is detected. This can induce immobilization of the wheels, in particular the wheels can be monitored in position, that is to say they keep the same position as the position measured when at least one electronic handle 200 is released.

Furthermore, when the measurement of the distance between the user and the robotic walker 1 is less than or equal to a predetermined value, for example 250 mm, the wheels remain stationary. Then, when the distance between the user and the robotic walker 1 is again greater than the predetermined value, for example 250 mm, and a force of interaction between the two hands of the user and the corresponding electronic handles 200 is detected, the immobilization of the wheels ceases.

Sensor Positioned on the User of the Robotic Walker 1.

A robotic walker 1 according to the invention can be coupled to a remote sensor positioned on a user of the robotic walker 1.

A remote sensor within the meaning of the present invention can for example correspond to an electronic device including an inertial unit, a heart rate measuring device or a device including pressure sensors.

Such an inertial unit advantageously allows following the gait of a user reliably. Indeed, the presence of an inertial unit, integrated for example in an object carried by the user, gives the possibility of following the user's gait independently of the use of the robotic walker. The inertial unit will analyze, in at least three dimensions, the user's gait. Based on the data of the inertial unit, the processing module will be able to determine an indicator of an involuntary movement, in particular based on occasional anomalies appearing in the user's gait.

The remote sensor positioned on the user of the walker can also correspond to one or several pressure sensors positioned in the soles of the user. Such a pressure sensor advantageously allows following the gait of a user reliably. Indeed, the presence of a pressure sensor in the soles gives the possibility of following, independently of the use of the robotic walker, the bearing forces of the user and more generally his gait. The pressure sensor(s) can be configured to continuously analyze the user's gait in real time. Based on the data of the pressure sensor, the processing module will be able to determine an indicator of an involuntary movement, in particular based on occasional anomalies appearing in the distribution of the forces exerted by the user's feet.

Thus, the remote sensor is advantageously configured to communicate with the control module 40 and transmit measured values to it.

Thus, alternatively, or additionally, the control module 40 can further be configured to determine the indicator of an involuntary movement of a user of the robotic walker 1 that could lead to a fall of said user based on values measured by a remote sensor.

Inclination Sensor

A robotic walker 1 according to the invention can also include an inclination sensor, for example located on the frame or in the control module 40. This inclination sensor can generate values taken into account by the control module during the identification of an indicator of involuntary movement. Indeed, the environment can influence the behavior of the user and his interaction with the robotic walker 1. For example, an involuntary movement on a planar surface could be a voluntary movement when entering a slope.

Thus, the control module 40 is preferably configured to take into account values generated by the inclination sensor when determining an involuntary movement of the user.

The inclination sensor can consist of an acceleration sensor with two or more axes, a gyroscopic sensor, or any other sensor that allows directly or indirectly measuring an inclination value.

Thus, in addition to the measurement of an angular position of the robotic walker 1 with respect to a vertical axis of said robotic walker 1 or to the measurement of the distance to a beacon indicating a prohibited area, the control module 40 can be configured to actuate the braking when the angular position or the distance to a beacon exceeds a predetermined threshold. This braking can for example be controlled via one or several displacement motors 20 serving as brakes or one or several braking unit(s) configured to carry out the braking or the release of the braking of said robotic walker 1 in stages as described previously.

Advantageously, in order to further improve the safety of the user, the robotic walker 1 may include a beacon transmitter and/or receiver. Such beacons can in particular be made as a sensor that allows measuring distances by calculating the time of flight of a wave. The beacon receiver can be configured to detect a signal reflected or emitted by a beacon transmitter placed in the environment in which the user moves. Indeed, such beacons can be positioned at different locations of the user's living space and are configured to communicate with the beacon receiver. Thus, the beacon receiver can be configured to detect the signal emitted by the beacon transmitter and the control module 40 is then advantageously configured to actuate a braking of the walker. This braking can particularly occur when the robotic walker 1 is at a distance smaller than a threshold value from the beacon transmitter. By way of non-limiting example, the beacon transmitter and/or receiver of the robotic walker 1 can correspond to any exteroceptive sensor and in particular to sensors comprising hardware and software components adapted to allow the communication according to the Bluetooth® standard, of the NFC type (nearfield communication) or of the radio-identification type.

Preferably, the beacon transmitter and/or receiver corresponds to an RFID reader (Radio Frequency IDentification).

Like the beacon receiver, the beacon transmitter can correspond to any beacon capable of reflecting or emitting a signal, and comprises hardware and software components suitable for communication according to the Bluetooth® standard, of the NFC type (nearfield communication) or of the radio-identification type.

In a preferred embodiment, the beacon transmitter corresponds to a passive radio tag encoding digital data and comprising an antenna and a chip. When the RFID reader passes in the vicinity of the passive radio tag, it sends requests to the passive radio tag in order to retrieve the data stored in memory. The passive radio tag, remotely powered by the signal from the RFID reader, first generates a code that allows identifying the area in which the robotic walker 1 is located or more generally is heading. Upon receipt of this code, the control module 40 can determine, by comparing the code received with a correspondence database stored in the data memory 42, whether the code corresponds to a prohibited area. If this is indeed the case, the control module 40 can be configured to control the braking of the robotic walker 1. The environment in which the user moves can thus comprise a plurality of beacons, this thus allows the user of the robotic walker 1 to avoid ending up in an area considered to be at risk, such as an area comprising a staircase, or an area near a road. It is also possible to lock down an external or internal area of a residence in order to prevent users of the robotic walker 1, in particular suffering from neurodegenerative diseases, from getting lost or leaving the place of residence. Thus, preferably, the beacon transmitter and/or receiver is configured to detect and identify a plurality of radio tags.

As discussed, the indicator of an involuntary movement can be determined from many sources. Preferably, it is determined from at least two sensors, preferably from at least three sensors. Indeed, the involuntary movement indicator will be more reliable when it is determined from at least three sensors such as the electronic handle sensors and at least one displacement sensor. In addition, the data from which the indicator of an involuntary movement will be determined may require processing operations. Thus, the control module 40 can be configured to process measured values so as to generate calculated values used for the determination of an indicator of an involuntary movement. The processing may vary depending on the sensors concerned and may for example include frequency filtering, standardizations, or even resampling operations.

Furthermore, as mentioned, the indicator of an involuntary movement can be determined from a comparison between a calculated or measured value and a predetermined threshold value. Another problem with the walkers can be their inability to meet different and changing needs. However, the needs of the walker users may change as their conditions improve or deteriorate. As a result, a walker that initially fits one person may gradually become unusable over time.

The predetermined values implemented by the robotic walker 1 according to the invention can be entered and updated via a man-machine interface (MMI). Such an MMI can form an integral part of the robotic walker 1 and be fixed thereto. Nevertheless, preferably, the MMI is occasionally coupled, in a wired or wireless manner, to the robotic walker 1.

Furthermore, the predetermined values implemented by the robotic walker 1 according to the invention can be calculated automatically based on data relating to the user and to his morphology entered for example via the MMI. Thus, these threshold values may change depending on the user information provided.

Advantageously, the predetermined values implemented by the robotic walker 1 according to the invention can be modified over time based on a learning implemented by the control module 40. Indeed, the control module or any computing unit coupled to the walker can advantageously implement a personalization procedure including supervised and/or unsupervised learning steps based on values generated from sensors coupled to the walker. Thus, the threshold values can be particularly adapted to the person using the walker according to the invention.

Particularly, the processing unit will be able to determine a personal profile of normality. This “normal” profile can for example correspond to a model of the characteristics of use of the walker that allows determining usual values such as usual values of force, force variation, speed, speed variation, distance or distance variation. The use of the “normal” profile then allows setting threshold values and/or detecting anomalies, the anomalies being particularly observations whose characteristics differ significantly from the “normal” profile and which could lead to a fall.

Particularly, the processing unit can determine reference values or predetermined threshold values by implementing a supervised or unsupervised learning method. Among supervised learning methods, neural networks, classification trees, nearest neighbor search or regression trees can be among the most robust and effective automatic learning techniques in the context of a method according to the invention.

Furthermore, the walking profile of the user of the robotic walker 1 according to the invention can be determined automatically based on calibration data measured for example by the sensors of the robotic walker 1. Such calibration data are for example measured during a step of calibrating the robotic walker 1. Thus, the calibration step may consist of a plurality of measurements by all the sensors of the robotic walker 1 during a use by the user. Threshold values used by the walker or the method according to the invention may change based on the specific user information acquired.

Advantageously, the calibration data can be labeled and serve as reference values, the data or measurements being for example associated with a reference gait, that is to say with a voluntary movement of the user. Indeed, the control module or any calculation unit coupled to the walker can advantageously implement a personalized calibration procedure including supervised and/or unsupervised learning steps based on the values generated from the sensors coupled to the walker.

Particularly, the processing unit can determine a calibrated profile. This “calibrated” profile can for example correspond to a prediction model trained from the characteristics of use of the walker. This prediction model may have been trained from the usual values of displacement such as usual values of force, force variation, speed, speed variation, distance or distance variation. The use of the “calibrated” profile then allows a more sensitive and specific detection of an involuntary movement of the user. For example, if the prediction model corresponds to a model capable of predicting a time series, then a measured value significantly deviating from a predicted value may be considered as an indicator of involuntary movement.

Furthermore, the control module 40 is configured to identify a previous position, at the given moment, of at least one of the wheels 11a, 11b, 12, and therefore more generally of the walker.

Particularly, it is configured to identify a previous position, prior to the given moment, of the wheel(s), preferably at least two wheels, 11a, 11b, 12 coupled to a displacement motor 20. Preferably, the previous position at the given moment corresponds to a position of the wheel(s) 11a, 11b, 12 at least ten milliseconds before the given moment, more preferably at least 50 milliseconds before the given moment, even more preferably at least 100 milliseconds before the given moment. For example, the previous position at the given moment may correspond to a position of the wheel(s) 11a, 11b, 12 at a time corresponding to the given moment minus a predetermined duration.

Thus, the robotic walker 1, for example the data memory 42, is configured to store the position of the wheel(s) 11a, 11b, 12, preferably of those being coupled to a displacement motor 20 as a function of time. In addition, it can store a predetermined duration which will be subtracted at the given instant so as to determine the previous position of the wheel(s) 11a, 11b, 12.

Furthermore, the control module 40 is configured to transmit to at least one of the wheels 11a, 11b, 12, preferably to at least two wheels, a command to stop the robotic walker 1. As mentioned, the walker includes one or several displacement motors 20 serving as brakes or one or several braking unit(s) configured to achieve the braking or the release of the robotic walker 1.

There are different types of braking units. For example, the brake unit can be frictional and have a pad, shoe or block structure which is moved so as to mechanically prevent the rotation of the walker wheel(s) or preferably by motor braking ensured by one or several displacement motor(s) 20 serving as brakes.

The stop command can be defined over time and therefore be associated with a predetermined stop duration. For example, the predetermined stop duration is comprised between 1 ms and 1 second. The stop is preferably immediate then followed by a displacement to find a previous position. Nevertheless, to avoid a possible shock to the user, the stopping is gradual and includes a slowdown of the walker before stopping and a resumption of a previous position. Furthermore, the stop command can include a predetermined duration of immobilization that allows setting a speed of displacement of the wheels before they stop. Thus, in the case of detection of risk of falling, the stopping of the walker will not be sudden but can be softened by defining a predetermined stop duration comprised between 10 ms and 1 second. This allows further reducing the discomfort of the user of the robotic walker 1. A predetermined duration of immobilization can be for example be comprised between 100 ms and 1 second.

Furthermore, the control module 40 is configured to transmit to at least one of the wheels 11a, 11b, 12, preferably to at least two wheels, a command to move the robotic walker 1.

This can allow the robotic walker 1 to find a position prior to the position it had at the identified given moment.

Thus, for example in the case where the robotic walker 1 would move forward too quickly, the robotic walker 1 would be stopped for example for a predetermined duration then it would move back so as to return to a previous position on detection of the risk of falling.

The balance of a standing man is achieved by the central nervous system by maintaining the projection of the center of mass in the base of support, this defines the static balance. When a man is moving, as when he walks, he does not fall, but his balance is said to be dynamic. The projection of the center of mass is no longer in the supporting base, which should lead to the fall, but is in fact a recoverable state of balance, because the next step brings back the center of mass from the back of the body to the supporting base (the sole of the foot on the ground) to pass it again, until the new step. Similarly, when the balance is disturbed by an unpredictable event, to recover his balance, the human will react. It is a process of reactive balance, such as moving the arms to bring back the trunk into a static balance or taking a step forward to be in dynamic balance. The present invention allows reactive balance assistance where the robotic walker will put the user in a recoverable state, then in static balance.

Thus, a user of the walker can find himself in a position that would not be a source of risk of falling.

Preferably, the instruction to move the robotic walker 1 includes a predetermined duration of return to the previous position allowing the control module 40 to determine a speed of displacement of the wheels. Furthermore, this duration may be a function of the distance to be traveled. Preferably, the walker will be configured so that this return to the previous position takes place at a ‘slow’ speed, preferably at a speed lower than the speed of displacement of the walker upon determining the indicator of an involuntary movement of the user.

Furthermore, the robotic walker 1 can be configured to store a predetermined duration of maintenance in the previous position. This duration corresponding to a duration during which the robotic walker 1 remains in the previous position. Preferably, this duration is less than one second.

As mentioned, a walker according to the invention can include at least one electronic handle 200, preferably two electronic handles 200.

As mentioned, the electronic handles 200 are arranged so as to be able to measure a force applied to them by a user.

The electronic handles 200 configured to measure a force applied to them can be equipped with a force sensor, torque sensors, a pressure sensor, a strain gauge, a piezoelectric type technology or simple button sensors.

Advantageously, the electronic handles 200 used in the context of the invention include a coupling between a photoelectric cell and an obturation element. A photoelectric cell can particularly correspond to a sensor consisting of an infrared emitter and a receiver placed oppositely. The emission area is therefore a line of infrared light. When an obturation element such as a flag enters between the emitter and the receiver, the amount of light received by the receiver is increasingly weak. The measurement of the current at the output of the sensor is proportional to the amount of light measured and therefore to the distance of penetration of the flag. This distance can then be brought back to the force, applied to the handle, which caused the displacement.

Thus, such an electronic handle authorizes the control of the robotic walker 1 without it being necessary for the user to carry sensors on him, or to activate buttons (or any other interface). Such an arrangement allows detecting a force, applied to the handle, greater than or equal to two kilograms but also much less. Furthermore, such an arrangement allows determining a value of the applied force and is not content with detecting the exceeding of a threshold. Thus, it may be possible for a processor to process information differently depending on the level of force that has been applied to the electronic handle.

Advantageously, an electronic handle 200 according to the invention is arranged so as to allow the measurement of at least one component of a force being applied thereto.

As illustrated in FIG. 2, FIG. 3 and FIG. 4, an electronic handle 200 according to the invention includes a central part 210 and an external casing 220.

The central part 210 of an electronic handle 200 according to the invention may have a substantially cylindrical shape. Nevertheless, as can be seen in the illustration of FIG. 2, preferably, the central part 210 includes at least one portion having a section including a ridge. It has for example a polygon-shaped section.

The central part 210 is made with a material preferably having a Young's modulus at least equal to 175 GPa (for gigapascals), preferably greater than 200 GPa. This allows giving the central part 210 a rigidity suitable for its use in the electronic handle according to the invention. The central part 210 can be made of metal, a metal alloy, a polymer or a composite assembly. Preferably, the central part 210 is made of stainless steel.

The central part 210 preferably has a minimum length of 300 mm (per millimeter) and a maximum length of 500 mm.

The external casing 220 of an electronic handle 200 according to the invention can have a substantially, preferably tubular, shape. It can include at least one portion having a section including a ridge. However, preferably, it has an ellipsoidal and more preferably circular section.

The external casing 220 is made of a material preferably having a Young's modulus of less than 200 GPa, more preferably less than 150 GPa and even more preferably less than 100 GPa. Such a constitution and the existence of an elasticity at the level of the external casing 220 allows improving the performances of the electronic handle according to the invention.

The external casing 220 can be made of metal, metal alloy, polymer or composite assembly. Preferably, the external casing 220 is made of aluminum.

The external casing 220 preferably has a minimum length of 300 mm and a maximum length of 500 mm. Furthermore, the external casing 220 can have an external diameter comprised between 20 mm and 40 mm and a wall thickness comprised between 1 mm and 3 mm.

Advantageously, the external casing 220 is arranged so as to be able, under the effect of a force including a vertical component, to move by at least one tenth, preferably one thousandth of a millimeter in translation relative to an axis orthogonal to a longitudinal axis of the central part 210. A force component value can be quantified from one tenth, preferably one thousandth of a millimeter of displacement.

A displacement of at least one tenth, preferably one thousandth of a millimeter can preferably correspond to a displacement of at least 0.001 millimeter to 1 millimeter.

Furthermore, the external casing 220 can be arranged so as to be able, under the effect of a force including a horizontal component, to move by at least one tenth, preferably at least one thousandth of a millimeter in translation relative to a longitudinal axis of the central part 210. A force component value can be quantified from one tenth, preferably one thousandth of a millimeter of displacement.

This is possible in particular in the absence of direct fixing between the external casing and the central part. In addition, the presence of seals capable of elastic deformations or even an arrangement of the central part also allows such translations.

An electronic handle 200 according to the invention includes a first photoelectric cell 230.

The photoelectric cells are electronic devices generally including a light-emitting diode capable of emitting light pulses, generally in the near infrared (e.g. 850 to 950 nm). This light is received or not by a photodiode or a phototransistor depending on the presence or absence of an object on the path of the light pulses. The photoelectric current created can be amplified and then analyzed.

In the context of the invention, a photoelectric cell can be selected among a photoelectric cell of the barrier type, of the reflex type, of the proximity type. Furthermore, it is possible to use optical fibers to modify the arrangement of the photoelectric cells in the context of the invention.

In the context of the invention, a photoelectric cell is preferably a barrier-type photoelectric cell for which the barrier consists of a first obturation element 240.

Such photoelectric cells can generally be inexpensive but robust compared to the commonly used sensors.

The first photoelectric cell 230 includes a first diode 231 able to emit a light beam. The diode of a photoelectric cell according to the invention can correspond to an infrared diode.

Furthermore, the first photoelectric cell 230 includes a first receiver 232 arranged to receive the light beam emitted by the first diode. Preferably and as illustrated in FIG. 2, the light beam emitted by the first diode is directed directly towards the first receiver 232.

The first photoelectric cell 230 is configured to generate a current of intensity proportional to an amount of photons received by the first receiver 232. Particularly, it is the first receiver 232 that, as a light transducer, will generate a modification of an electrical signal in response to the incident light beam on its surface. The first receiver 232 can for example be a photoconductor, a photodiode or a phototransistor.

Preferably, a photoelectric cell according to the invention is configured to generate an electric current whose intensity will be proportional to the amount of photons received by the receiver.

Furthermore, the electronic handle 1 includes a first obturation element 240 which is able or arranged to modify the amount of photons received by the first receiver 232. Particularly, this modification of the amount of photons received is a function of the position of the first obturation element 240 relative to the first photoelectric cell 230.

An obturation element within the meaning of the invention may consist of metal, metal alloy, polymer or composite assembly. Preferably, the obturation element is made of polymer, more preferably thermoplastic polymer.

The first obturation element 240 may include a protuberance 241 arranged so as to be positioned between the diode 231 and the receiver 232 of the photoelectric cell 230. The protuberance 241 can be removably or non-removably fixed to the first obturation element 240. Furthermore, in the absence of protuberance 241, it is the obturation element that is housed between the diode 231 and the receiver 232.

It is important that the first photoelectric cell 230 and the first obturation element 240 can be movable at least partly relative to each other. Indeed, it is in particular the movement of one relative to the other, preferably of at least a portion relative to the other, which will allow a measurement of a component of a force applied to the electronic handle 200 according to the present invention. Alternatively, the first obturation element 240 and the first photoelectric cell 230 are fixed directly or indirectly on portions of the central part and these portions can be movable relative to each other.

Thus, according to one embodiment illustrated in FIG. 4 or 5, among the first photoelectric cell 230 and the first obturation element 240, one is fixed to the external casing 220 and the other is fixed to the central part 210. Particularly, if one is fixed to the external casing, it will not be fixed to the central part and vice versa. FIG. 3 shows, for example, means for fixing 242 the first obturation element 240 to the external casing 220. The fixing is preferably a removable fixing.

Particularly, the positioning of the first photoelectric cell 230 and of the first obturation element 240 or the fixing of the obturation element 240 to the external casing 220 will be carried out in such a way that a force F1 applied to the electronic handle 200, if it is sufficient to move at least partly the external casing 220 then it will cause a modification of the amount of photons received by the first receiver 232. Furthermore, as the position of the first obturation element 240 allow influencing the amount of photons received by the first receiver 232 then, the modification of the amount of photons received by the first receiver 232 will be correlated, preferably proportional, to a first component of the force having been applied to the electronic handle 200.

As illustrated in FIG. 4, the fixing will be carried out in such a way that a force F2 applied to the electronic handle 200, if it is sufficient to move at least partly the external casing 220, leads to a modification of the amount of photons received by the first receiver 232. In addition, the position of the first obturation element 240 that allows influencing the amount of photons received by the first receiver 232 then, the modification of the amount of photons received by the first receiver 232 will be correlated, preferably proportional, to a second component of the force having been applied to the electronic handle 200. As illustrated, the handle can include an element 270 capable of elastic deformation, for example made of polymer, so as to allow a translation of the external casing 220 relative to the central part 210.

Thus, the electronic handle according to the present invention can include a sensor of a vertical or horizontal force component whether or not passing through a measurement of a displacement of the external casing relative to the central part 210, the displacement being caused by a force including a vertical component and/or a horizontal component. Thus, the displacement can concern only part of the external casing and can be understood as a deformation of the external casing.

In one particular embodiment, the electronic handle 200 includes a fixed horizontal axis, for example made of steel, capable of being linked to a walking assistance apparatus (e.g. walker) and which serves as a reference. It also includes an external casing 220 that can take the form of an external tube which can move, under the effect of the horizontal component of the force, by a tenth of a millimeter in translation with respect to the central axis and which, under the effect of the vertical component of the force, deforms in the sagittal plane like an embedded beam. This force can be measured by a processor, for example placed in the electronic handle 200 or in the walking assistance apparatus.

As illustrated in FIG. 5, a photoelectric cell as used in the context of the present invention is preferably configured so as to be able to generate an electric signal whose intensity is correlated, preferably proportional, to the position of an obturation element. Thus, the modification of the amount of photons received by the receiver will be proportional to a component of the force having been applied to the electronic handle 200.

As shown in FIG. 5, the relationship between distance and intensity is preferably linear over at least 1 mm.

As illustrated in FIG. 6, an electronic handle 200 according to the present invention may also include at least one second photoelectric cell 250.

This second photoelectric cell 250 can share the same characteristics as the first photoelectric cell 230 and particularly its preferred or advantageous characteristics.

Like the first photoelectric cell, the second photoelectric cell 250 includes a second diode 251 able to emit a light beam. It also includes a second receiver 252 arranged to receive said light beam.

In addition, the second photoelectric cell 250 is arranged so that a force applied to the electronic handle 200 is able to cause a modification of the amount of photons received by the second receiver 252. Generally, the force applied to the electronic handle 200 will be able to cause a modification in the amount of photons received by the second receiver 250 if it is able to move at least partly the external casing 220.

The electronic handle 200 may also include a central part 210 arranged so that a portion of the central part 210 moves under the action of a force F1 applied to said electronic handle 200, leading to a modification of the amount of photons received by the first receiver 232 and that a portion of the central part 210 moves under the action of a force F2 applied to the electronic handle 200, resulting in a modification of the amount of photons received by the second receiver 252.

Advantageously, the modification of the amount of photons received is proportional to a second component of the force having been applied to the electronic handle 200.

Thus, the presence of a second photoelectric cell 250 allows better characterizing the force applied to the electronic handle 200.

Beyond the ability to measure a second force component, this allows calibration of the electronic handle without manual intervention on the handle and its electronics. Indeed, a ‘zero’ is obtained when no force is applied on the system and the force measured can correspond to a percentage of displacement of the obturation element, for example relative to a maximum displacement.

The photoelectric cells 230, 250 can be fixed directly to the central part 210.

As illustrated in FIG. 6, the photoelectric cells 230, 250 can be fixed indirectly to the central part 210. Particularly, an intermediate element 211 can be used. The intermediate element 211 is fixed to the central part 210 while the photoelectric cells 230, 250 are fixed to the intermediate element 211. This can allow manufacturing a handle according to the invention more quickly and facilitates any maintenance thereof.

Furthermore, an electronic handle 200 according to the present invention can also include an electronic card 280. Such an electronic card 280 may be configured to measure the output voltage of the photoelectric cell then transform it into a digital data.

Advantageously, the electronic card 280 is configured to sample the measurement of the current over 10 bits, which corresponds to 1,024 values. Such a sampling allows a resolution of the measurement on the order of a thousandth of a millimeter.

Particularly, the electronic card 280 is configured to measure an output voltage or current and sample it over at least 4 bits, preferably at least 10 bits.

Considering the correlation between the output voltage or intensity and the displacement in millimeters of an obturation element or of the external casing 220 relative to the central part 210 or to a photoelectric cell on the one hand and the correlation between the displacement in millimeter of the external casing 220 relative to the central part 210 and the force applied on the other hand, the electronic card 280, or an electronic card disposed outside the handle, can be configured to transform the information generated by a photoelectric cell into information on the intensity of the force applied to the electronic handle.

As shown in relation to FIG. 6 and FIG. 7, an electronic handle 200 according to the present invention can also include a second obturation element 260.

The horizontal and vertical displacement measurements can then be decoupled. A first sensor is used to measure the deformation of the electronic handle 200 due to a vertical component F1 and a second sensor is used to measure the horizontal displacement of the handle due to a horizontal component F2. In addition, the presence of the two sensors allows automatic calibration (i.e. without manipulation of the sensor).

This second obturation element 260 can share the same characteristics as the first obturation element 240 and particularly its preferred or advantageous characteristics. For example, the second obturation element 260 can include a protuberance 261 arranged to intersect the light beam generated by the second diode 251.

Thus, the second obturation element 260 is capable of modifying the amount of photons received by the second receiver 252 (not represented in FIG. 7). This modification is particularly a function of its position relative to the second photoelectric cell 250.

Furthermore, the second closure element 260 can include a membrane 262, said membrane 262 being arranged to transmit a displacement of the external casing 220, for example subjected to a horizontal force component, to a protuberance 261. Particularly, the connection with the external casing 220 can be a slat which deforms according to the force exerted horizontally by the user. A protuberance such as a flag used for measurement is rigidly fixed on this slat. The deformed part remaining in its elastic area, the deformation is proportional to the force. Alternatively, the second obturation element 260 and the second photoelectric cell 250 are fixed directly or indirectly on portions of the central part and these portions can be movable relative to other. Preferably, the central part is arranged so that the second obturation element 260 and the second photoelectric cell 250 are fixed directly or indirectly on portions of the central part which can move independently and portions of the central part on which the first obturation element 240 and the second photoelectric cell 250 are directly or indirectly fixed.

Advantageously, the second component of the force will be perpendicular to the first component of the force.

Thus, the electronic handle 200 can include a sensor for the deformation of the external casing 220, and more widely of the electronic handle 200, due to a horizontal component.

For that purpose, the second photoelectric cell 250 is preferably positioned substantially perpendicularly, preferably perpendicularly to the first photoelectric cell 230. More particularly, the axis of a light beam formed by the first photoelectric cell 230 is perpendicular to the light axis formed by the second photoelectric cell 250.

In one embodiment, when the electronic handle 200 includes a second photoelectric cell 250 and a second obturation element 260, one is fixed to the external casing 220 and the other, not being fixed to the external casing 220, is fixed to the central part 210.

Nevertheless, when the electronic handle 200 includes a second photoelectric cell 250 and a second obturation element 260, advantageously one is fixed to the central part 210 and the other, not being fixed to the central part 210, is fixed to a part coupled to the electronic handle. This part can for example correspond to a junction element between the electronic handle and a chassis element of the robotic walker 1.

Alternatively, as has been mentioned and as will be detailed later, the obturation elements and the photoelectric cells can all be fixed to the central part. This fixing can be direct or indirect.

Generally at least one obturation element 240, 260 is fixed directly or indirectly to the external casing 220. This fixing can be a removable or non-removable fixing. Furthermore, in one embodiment, if an obturation element is fixed to the external casing 220 then it will not be fixed to the central part 210.

Similarly, at least one photoelectric cell 230, 250 is fixed directly or indirectly to the external casing 220. This fixing can be a removable or non-removable fixing. Furthermore, if a photoelectric cell is fixed to the external casing then it will not be fixed to the central part 210.

Advantageously, the photoelectric cell(s) 230, 250 are fixed to the ends of the external casing 220. Preferably they are fixed to the opposite ends of the external casing 220. Particularly, as illustrated in FIG. 7, the photoelectric cell 230 (not represented in FIG. 7) arranged for a measurement of a vertical force component F1, is preferably positioned in a proximal quartile P of the electronic handle 200 while the photoelectric cell 250 arranged for a measurement of a horizontal force component F2 is preferably positioned in a distal quartile D of the electronic handle 200. This allows an improvement in the accuracy of the measurements and in the sensitivity.

Advantageously, to facilitate the horizontal displacement of the external casing, linear ball bearings are used and a part of the linear ball guide type allows making the connection between the central axis and the external tube.

The external casing can further be covered with an ergonomic shape 221 to facilitate the gripping of the electronic handle 200. The ergonomic shape 221 can be made of polymers or any other material.

Thus, the effort applied by a hand on the handle can be modeled by a force, in the sagittal plane, having a vertical component, F1, and a horizontal component, F2, in the direction of the user's walk. Such an electronic handle allows ignoring the compressions performed by the user when using the handle to focus on the actions including a force associated with a given direction.

As mentioned, a robotic walker 1 according to the invention is configured so that it can be intuitively monitored by a user. Particularly, a robotic walker 1 according to the invention is configured so that at least one displacement motor 20 can be monitored by a user from manipulation of the electronic handles.

As presented in relation to FIG. 8, an electronic handle 200 according to the present invention can also be arranged so as to allow the measurement of at least two components of a force applied thereto.

For that purpose, each of the electronic handles 200 can advantageously include a central part 210 comprising a first photoelectric cell 230, a first obturation element 240, a second photoelectric cell 250 and a second obturation element 260.

As already partly detailed in relation to FIGS. 1 to 7, the obturation elements 240, 260 are arranged so as to be able, depending on their position relative to their respective photoelectric cell 230, 250, to modify the amount of photons received by the receiver 232, 252.

In this embodiment, the first photoelectric cell 230 and the first obturation element 240 are arranged so that a force applied to the electronic handle 200 including a first component and able to move at least partly the central part 210, or able to cause a modification of the amount of photons received by the first receiver, the modification being proportional to a first component of the force having been applied to the electronic handle 200.

Furthermore, the second photoelectric cell 250 includes a second diode 251 able to emit a light beam and a second receiver 252 arranged to receive said light beam. The second photoelectric cell 250 is configured to generate a current of intensity proportional to an amount of photons received by the second receiver 252.

The second obturation element 260 is capable, depending on its position relative to the second photoelectric cell 250, of modifying the amount of photons received by the second receiver 252.

In addition, the second photoelectric cell 250 and the second obturation element 260 are arranged such that a force applied to the electronic handle 200 including a second component and able to at least partly move the central part 210, namely able to cause a modification of the amount of photons received by the second receiver 252, said modification being proportional to a second component of the force having been applied to the electronic handle 200.

It is thus possible to determine at least two components of a force applied to each of the two handles and directly causing a displacement (at least partial deformation) of the central part 210. The two electronic handles 200 can thus be configured to control at least part of a motor equipping a robotic walker 1 based on the values of the two calculated force components.

By way of non-limiting example, the command of the motor can generate a displacement of a motorized device such as a robotic walker 1. Such a command can be subject to the determination of the values of the two components of an applied force and calculated respectively for the two handles.

In order to allow independence of the measurements between the two components of an applied (for example horizontal) force F2 on each of the electronic handles 200, these (and particularly the position of the photoelectric cells and of the obturation elements) can be arranged such that the first component of the force F2 applied to the electronic handle 200 is not able to cause a modification of the amount of photons received at the level of the second photovoltaic cell 250 but only at the level of the first photovoltaic cell 230.

Similarly, each of the electronic handles 200 can also be configured so that the force applied to the electronic handle 200, including a second component perpendicular to the first component, is not able to cause a modification of the amount of photons received at the level of the first photovoltaic cell 230 but only at the level of the second photovoltaic cell 250.

In addition, the central part 210 can include a region 210-1 for attachment to a motorized device such as a robotic walker 1 according to the present invention as well as a bearing region 210-2.

The attachment region 210-1 may consist of a longitudinal extension of the bearing region 210-2 and can comprise a plurality of housings, such as for example a plurality of screw threads, adapted to receive fixing elements, such as, by way of non-limiting example, a plurality of screws, that allow connecting the electronic handle 200 to the robotic walker 1.

The bearing region 210-2 is adapted to allow a user to bear on it when the user interacts with the robotic walker 1. Thus, in this embodiment, it is the central part 210 which directly undergoes a deformation during the application of a force exerted by the user.

In order to provide independent measurements in at least two dimensions, that is to say in order to measure at least two components of a force applied on the electronic handle 200 in an independent manner, the bearing region 210-2 of the central part 210 can advantageously comprise at least one embedded beam and one deformation bridge.

The embedded beam advantageously comprises an embedded end 211-1, 211-3 and a free end 211-2, 211-4. The embedded end 211-1, 211-3 is connected to the central part while the free end 211-2, 211-4 is arranged to be movable along a longitudinal axis of the central part 210 authorizing a displacement of said free end during the application of a force on the electronic handle 200. Advantageously, the embedded beam is arranged such that the free end 211-2, 211-4 is able to move during the application of a force according to a first component but is not able to move during the application of a force according to a second component perpendicular to the first component.

By way of illustrative example, the free end 211-2, 211-4 can move (under the effect of the deformation of the beam) along a specific axis, such as the axis of one of the components of the applied force. This thus allows generating a displacement of the free end 211-2, 211-4 only if the applied force has a given non-zero component. For example, the free end 211-2, 211-4 may have a degree of freedom authorizing a displacement of said free end along the axis of the second component of the applied force, said second component of the applied force possibly corresponding to a horizontal component F2.

Furthermore, a deformation bridge 212 of the central part 210 can comprise a through opening 212-1 opening out onto a recess 213. The through opening 212-1 is arranged to be able to undergo an elastic deformation during the application of a force on the electronic handle 200. More particularly, the volume of the through opening 212-1 can increase or decrease depending on the application of the force on the electronic handle 200.

By way of illustrative example, the through opening 212-1 can be arranged so that its volume varies only upon application of a force including a particular component. This allows generating an increase or a decrease in the volume of the through opening 212-1, by a displacement of the central part 210 and more particularly of the bearing region 210-2, only if the applied force has a non-zero data component (e.g. vertical component).

Thus, the increase or decrease in the volume of the through opening 212-1 can be generated along a specific axis of an applied force, such as the axis of one of the components of the applied force. For example, the through opening 212-1 can be arranged so as to authorize a displacement of the bearing region 210-2, and therefore an increase or decrease in the volume of the through opening 212-1 along the axis of the first component of the applied force, said first component of the applied force possibly corresponding to a vertical component F1.

Advantageously, the second photoelectric cell 250 can be fixed to the central part 210, within a suitable cavity. The second obturation element 260 will be in this case directly fixed to a free end 211-2, 211-4 of an embedded beam. Indeed, the application of a force on the bearing region 210-2, if it is sufficient, will induce an elastic deformation of the central part 210. Such a deformation can be measured if the second component of the applied force is non-zero, resulting in a modification of the amount of photons received by the second receiver 252. Indeed, the elastic deformation will cause a displacement of the second obturation element 260 fixed to the free end 211-2 along the axis of the second component of the applied force thus blocking all or part of the light beam received by the receiver 252 and generated by the diode 251.

In order to measure the first component of the force applied on the bearing region 210-2, the first photoelectric cell 230 and the first obturation element 240 can be respectively positioned on either side of the through opening 212-1 of the deformation bridge 212. Indeed, the application of a force on the bearing region 210-2, if it is sufficient, will induce an elastic deformation of the central part 210. Such a deformation can be measured if the first component of the applied force is non-zero, leading to a modification in the amount of photons received by the first receiver 232. Indeed, the elastic deformation will lead to a displacement of the first obturation element 240 fixed on the central part 210, more particularly in a suitable housing 214, along the axis of the first component of the applied force, thus blocking all or part of the light beam received by the receiver 232 and generated by the diode 231.

In order to reduce the weight of the central part 210, the central part 210 can include at least two central openings 216-1, 216-2 through which a portion 215 of the central part passes that allows ensuring sufficient rigidity to avoid any significant deformation or rupture of the central part 210 during its manipulation by the user, said central openings being positioned in the center of the central part, more particularly between the ends of the central part 210.

Furthermore, in order to facilitate the passage of power supply cables, the central part 210 can advantageously include a recess (not represented in the figures) running longitudinally through the central part 210. Such a recess allows in particular the passage of the power supply cables from the walker to the electronic handle 200 and more particularly said recess allows connecting the photoelectric cells 230, 250 so that they can be powered.

As described previously, each of the electronic handles 200 can comprise an external casing 220, said external casing 220 being coupled and/or fixed to the central part 210. Preferably, the external casing 220 is not fixed to the central part 210 but is only coupled for example by one or several force transmission elements.

For that purpose, one or several force transmission elements of the external casing 20 are arranged so as to pass through a housing formed in the free end 211-2, 211-4 of the embedded beam. A force transmission element can for example correspond to a screw, a tube, a cylinder, like a pin linking the two portions of the external casing 220 and passing through the central part 210 in a first housing formed in the free end 211-2, 211-4 of the embedded beam and/or in a second housing formed in the central part 210.

Preferably, in the absence of force applied to the electronic handle, the force transmission element is not in direct or indirect contact with the central part 210. Preferably, the first housing formed in the free end 211-2, 211-4 of the embedded beam and the second housing formed in the central part 210 includes a force transmission element, such as a pin, having a clearance fit. The external casing 220 preferably transmits the efforts external to the central part 210 by the pin passing through the central part at its second housing and by the pin passing through the central part at its first housing formed in the free end 211-2, 211-4.

Particularly, the pins can correspond to metal cylinders passing through the central part 210 at the level of a first housing provided in the free end 211-2, 211-4 and at the level of a second housing provided in the central part 210 housed in the external casing 220. These pins are advantageously mounted with a clearance so as to rotate freely, therefore they only transmit forces from the external portion to the central part 210.

By way of illustrative example, in order to allow the transmission of a horizontal displacement, during the application of a force on the electronic handle 200, by the force transmission element passing through the first housing formed in the end free 211-2, 211-4 of the embedded beam, it is expected that the first housing is arranged to accommodate the force transmission element. The force transmission element, advantageously taking the form of a pin, allows connecting the central part 210 to the external casing 220 of the electronic handle 200.

Furthermore, in order to allow the transmission of a vertical displacement, during the application of a force on the electronic handle 200, by the force transmission element passing through the second housing of the central part 210, it is expected that the second housing provided in the central part 210 takes the form of an oblong hole and is arranged to accommodate a ball bearing adapted to enclose said force transmission element. Thus, the force transmission element passing through the second housing of the central part 210, advantageously taking the form of a pin, has a degree of freedom in translation and in rotation relative to the central part 210 of the electronic handle 200.

Such force transmission elements allow avoiding torsional forces which can interfere with the measurements during the application of a force by a user. Thus, such an arrangement allows improving the accuracy of the measurement and particularly its linearity.

An electronic handle 200 can also include a fixing element such as a screw passing through the central part 210 in the central openings 216-1, 216-2 and/or within a cavity comprising the second photoelectric cell 250.

Indeed, it is expected that the external casing 220 can take the form of two half-shells arranged to accommodate the central part 210. For that purpose, the fixing element is arranged to establish a reversible mechanical connection between the two half-shells forming the external casing 220.

Such a fixing element allows avoiding the torsional forces which can interfere with the measurements when a user applies a force, since the fixing element is not in contact with the central part 210.

Thus, at least one of the electronic handles 200 includes a sensor coupled, preferably operatively, to a control module 40 and the control module 40 is configured so as to be able to control the displacement motor 20. Particularly, and as illustrated in FIG. 9, the control module 40 can control the displacement motor 20 based on values transmitted by the sensor of the electronic handle 200. In addition, the electronic handle 200 can include several sensors coupled, preferably operatively, to the control module 40.

The coupling allows the sensor to transmit data to the control module. The operative coupling of one or several sensors of one of the electronic handles 200 to the control module can correspond to a transmission of information, such as current values (intensity or voltage) from the sensors to the control module, either directly or indirectly. Furthermore, this operative coupling can include a fusion of the information coming from the sensors so that the control module can give an instruction to one or several motors based on values coming from several sensors. Such sensor fusion allows for example detecting the user's intention to get up to synchronize the movement of the walker with the movement of the human.

Since the electronic handle 200 is equipped with sensors and electronics, it is necessary to bring cables from the location of the electronics on the chassis. The cables are, for example, integrated directly into the chassis or fixed thereto.

Preferably, the sensor of the electronic handle 200 is arranged so as to be able to measure at least one component of a force applied to the electronic handle 200.

The sensor of the electronic handle 200 can be any device arranged and configured to measure the value of a force or an effort. For example, a sensor of the electronic handle 200 can be selected among: a force sensor, a pressure sensor, a barrier photoelectric cell, a displacement sensor. Particularly, the sensor of the electronic handle 200 can include a strain gauge, a resistive force sensor or a photoelectric cell. Preferably, the electronic handle 200 according to the invention includes at least one photoelectric cell 230.

Furthermore, the control module 40 may include a communication module 43 ensuring a communication between the different components of the control module 40, in particular according to a suitable wired or wireless communication bus.

Preferably, the communication module 43 is configured to ensure the communication of the data measured by the sensors of a robotic walker 1 according to the invention to a data memory configured to record such data. Furthermore, the communication module also allows the communication between the processor and the data memory in particular to calculate a value based on the stored data, said value can then be recorded directly in a suitable field in the data memory. Finally, the communication module also allows the processor to control a displacement motor of a robotic walker 1, in particular a command of the motor can be associated with a value calculated based on the data measured by the sensors.

Furthermore, the control module 40 can include a Man Machine Interface (MMI) 44.

The latter can advantageously be arranged to cooperate with a processor, the man-machine interface can correspond to one or several LEDs, indicator light, sound signal, tactile signal (vibrations), a screen, a printer, a communication port coupled to a computing device or any other interface for communicating with a human perceptibly through one of his senses or a computing client through a communication link.

Such an MMI can also be used to configure the control module. Particularly, the control module can interact via an MMI with other electronic devices or connected objects 5 so as to collect parameterization data. Such parameterization data can for example correspond to predetermined threshold values or predetermined durations.

Furthermore, a robotic walker 1 according to the invention is equipped with a suitable power supply source (not represented in the figures) allowing the different elements of said robotic walker 1 to operate. Such a power source generally consists of a battery or a plurality of batteries arranged to deliver the sufficient electrical energy to allow the operation of the displacement motor(s) or to ensure the operation of the different components of the control module.

A robotic walker 1 according to the invention cannot be limited to a single control module 40, it is provided, in one particular embodiment, that the robotic walker 1 comprises a control module dedicated to each handle. Each of the control modules can thus be arranged inside or outside the handle with which it is associated. Furthermore, the walker can include an electronic power card per motor which allows monitoring the energy sent to said motor.

In one particular embodiment, a robotic walker 1 includes a chassis 10 having a front portion 10a and a rear portion 10b, a pair of wheels 11a, 11b being arranged to support the rear portion 10b of the chassis 10, and a wheel 12 or a pair of wheels being arranged to support the front portion 10a of the chassis, the two wheels 11a, 11b, 12 of a pair of wheels being motorized, that is to say each coupled to a displacement motor 20, said robotic walker 1 further including:
a control module 40 configured to control the displacement motors 20;
a data memory 42, coupled to the control module 40, configured to store a predetermined value of the force multiplier coefficient and a predetermined value of the walking assistance adjustment coefficient;
two electronic handles 200 each including at least one sensor operatively coupled to the control module 40, said sensor being configured to generate data of the force of interaction between a hand of the user and the robotic walker 1;
at least one displacement sensor configured to measure displacement data of the walking assistance robotic walker 1; the control module 40 being configured to:
   Determine a value of the force of interaction between a hand of the user and the robotic walker 1 for each of the electronic handles 200 based on the data generated by each of the sensors of the electronic handles 200;
   Determine a value of the speed of displacement of the robotic walker 1 based on measured displacement data;
   Calculate, for each of the motorized wheels, an increment value based on:
      values of the force of interaction between a hand of the user and the robotic walker 1 corrected with the predetermined value of the force multiplier coefficient, and
      the value of the speed of displacement of the robotic walker 1 corrected by the predetermined value of the walking assistance adjustment coefficient.

This walking assistance complements the fall prevention capacities of the walker according to the invention to reduce the risks of falls for users of a walker according to the present invention.

Depending on other optional characteristics of the robotic walker, it may optionally include one or several of the following characteristics, alone or in combination:
the predetermined value of the force multiplier coefficient is generated by a learning model.
the predetermined value of the walking assistance adjustment coefficient is generated by a learning model.
the adjustment coefficient can take into account a plurality of calibration parameters such as a detection force F_{mD} of the right hand and/or of the left hand F_{mG} for each of the corresponding electronic handles, a bearing force F_{aD} of the right hand and/or of the left hand F_{aG} on each of the corresponding electronic handles, a walking resistance k (virtual weight) in a straight line, a walking resistance k′ (virtual weight) in turns, a force for which the speed remains constant in translation Fₙₒₘ, a minimum force for actuating the displacement motors Fₘᵢₙ, a force for which the speed remains constant in rotation ΔFₙₒₘ, a minimum force in rotation ΔFₘᵢₙ, resolution of the handle, a minimum distance Dₘᵢₙ between the user and the robotic walker, a maximum distance Dₘₐₓ between the user and the robotic walker.

According to another aspect, the invention relates to a method for preventing 100 a fall of a user of a robotic walker 1, preferably of a robotic walker 1 according to the invention.

A prevention method 100 according to one embodiment of the invention, implemented by a control module 40 including program instructions previously recorded in a data memory 42 of said control module, is illustrated in FIG. 10.

As illustrated, a method for preventing 100 a fall of a user of a robotic walker 1 includes the steps of determining 110, at a given moment, an indicator of an involuntary movement of a user of the robotic walker 1, a step of identifying 120 a previous position, at the given moment, of at least one of the wheels 11a, 11b, 12, a step of transmitting 130 an immobilization instruction to the displacement motor 20 of the robotic walker 1 for a predetermined stop duration, and a step of transmitting 140 a displacement instruction to the displacement motor 20 of the robotic walker 1 so that it returns to the previous position at the identified given moment.

Thus, as illustrated in FIG. 9, a method for preventing 100 a fall of a user of a robotic walker 1 includes a step of determining 110, at a given moment, an indicator of an involuntary movement of a user of the robotic walker 1 that could lead to a fall of said user. As specified above, the indicator of an involuntary movement of a user can be determined from a multitude of sensors, located on the chassis 10 of the robotic walker 1, or in an electronic handle 200 or directly on the user of said robotic walker 1. This identification step 110 can correspond to the comparison of a value measured by one of the sensors with a predetermined threshold value or the comparison of a variation calculated over a predetermined time interval with a predetermined threshold variation value. The nature of such a variation, over a given interval, may differ depending on the type of sensors. It may in particular be a variation force for a pressure sensor, or a distance variation for a distance sensor, between the trunk of the user and the chassis 10, of the robotic walker 1, or a speed variation, for a sensor configured to measure the displacement of a wheel of a robotic walker 1.

A method for preventing 100 a fall of a user of a robotic walker 1 further includes a step of identifying 120 a previous position at the given instant of at least one of the wheels 11a, 11b, 12, preferably at least two wheels.

Following the identification 110 of an indicator of an involuntary movement performed in a given moment interval, it is advantageous to be able to determine what was the previous position of the robotic walker 1, that is to say before the involuntary movement of said user has taken place. For that purpose, the identification step 120 can advantageously allow determining an angular variation and a direction taken by at least one of the wheels 11a, 11b, 12, preferably at least two wheels. Indeed, the positions of at least one of said wheels are stored in the data memory 42 of the control module 40 as a function of time, which allows easily identifying the position of at least one of the wheels, preferably at least two wheels, before the identification of the involuntary movement.

A method for preventing 100 a fall of a user of a robotic walker 1 further includes a step of transmitting 130 to the displacement motor 20 an instruction to immobilize the robotic walker 1, for example for a predetermined stop duration previously recorded in the data memory 42 of the control module 40. This allows completely immobilizing the robotic walker 1 in order to prevent the fall of the user.

A method for preventing 100 a fall of a user of a robotic walker 1 further includes a step of transmitting 140 to the displacement motor 20 an instruction to move the robotic walker 1 so that it returns to the previous position, at the identified given moment, of the at least one of the wheels 11a, 11b, 12, preferably at least two wheels. Such a step advantageously helps the user of the robotic walker 1 to restore his position relative to said robotic walker 1. Indeed, as seen above, the robotic walker 1 can comprise various sensors and an involuntary movement can as well be associated with a loss of balance, involving for example the application of a pronounced force on an electronic handle 200, or a movement away from or closer to the user's bust relative to the chassis 10 of the robotic walker 1, or a sudden acceleration of the speed of rotation of one of the wheels of the robotic walker 1, causing in one case or the other a displacement or not of the robotic walker 1. Thus, in order to avoid any fall of the user of said robotic walker 1, the transmission step 140 is particularly suitable for facilitating the restoration of the user's balance.

According to another aspect, the invention relates to a method for controlling 300 a robotic walker 1, preferably a robotic walker 1 according to the invention.

A control method 300 according to one embodiment of the invention is illustrated in FIG. 11. As illustrated, a method for controlling 300 a robotic walker 1 includes the steps of measuring 320 at least one value of the force applied to an electronic handle 200, of comparing 330 the at least one value of the force applied to a predetermined threshold force value, and of generating 360 a control instruction to at least one of the displacement motors 20 of the robotic walker 1. Furthermore, a method for controlling 300 a robotic walker 1 can include the steps of personalizing 310 the robotic walker 1, of calculating 340 a value of the variation over time in a force applied to an electronic handle 200, of comparing 350 the value of the time variation in a force applied to a predetermined threshold value.

Thus, as illustrated in FIG. 10, a method for controlling 300 a robotic walker 1 can include a step of personalizing 310 the robotic walker 1. Indeed, a control method is advantageously adapted to the user of the robotic walker 1. Thus, it will be advantageous, for example during a first use, to calibrate the robotic walker 1 and to adapt its operation to the morphology and physiology of a given user. Particularly, the personalization step 310 may include storage, for example on a data memory 42, of:
a predetermined threshold value of the applied force,
a predetermined threshold value of the variation in the applied force,
a predetermined threshold value of the speed of at least one of the wheels 11a, 11b, 12, preferably at least two wheels,
a predetermined threshold value of the distance variation, and/or
a predetermined distance threshold value.

Alternatively, these threshold values may have been prerecorded in a data memory 42 during the design of the robotic walker 1.

The storage of such data allows, on the one hand, adapting the walker in its operation to the morphology of a given user. Indeed, depending on the level of autonomy of the user, or his propensity to lose balance, and depending on the sensors positioned on said robotic walker 1, it may be advantageous to adapt the different thresholds in order to prevent any risk of fall. In the remainder of the description, the steps of the control method 300 are described in relation to a force sensor applied to an electronic handle 200. However, the invention cannot be limited to this embodiment and can include in combination or instead of such a force sensor applied to an electronic handle, a distance sensor or a sensor configured to measure a variation in the speed of a wheel of the robotic walker 1.

A method for controlling 300 a robotic walker 1 includes a step of measuring 320 at least one value of the force applied to an electronic handle 200. This measuring step 320 can correspond to the generation of a value of a component of a force applied to the electronic handle 200 by a user. Preferably, the applied force whose value is measured corresponds to a vertical component of the applied force. Thus, the detection of the bearing of a user on said handle is made at least partly by measuring the vertical force of bearing on the electronic handle 200. Advantageously, this step can include the measurement 320 of at least two components of the force applied to the electronic handle 200. Furthermore, this measurement 320 can be preferably carried out for the two electronic handles 200.

This step can be carried out by one or several sensors of an electronic handle 200.

A method for controlling 300 a robotic walker 1 includes a step of comparing 330 the at least one value of the applied force with a predetermined threshold value of the applied force and/or of the measurement of the distance between the user and the robotic walker 1. Such a comparison allows generating a user posture indicator. For example, the comparison step can lead to generating a binary value (e.g. yes/no).

Indeed, a method according to the invention can advantageously detect a posture of a user and particularly his ability or his need to set the robotic walker 1 in motion, by the detection that a threshold value has been exceeded by a measured value of the applied force.

This comparison step can also include the generation of a posture indicator in the form of an alphanumeric value or a numerical value. A numerical value could for example correspond to a difference between the measured value and the predetermined threshold value. A posture indicator value can advantageously be used in combination with other values upon generation of a control instruction.

This step can be carried out by a control module 40 and particularly by a processor 41 configured to perform such a comparison and generate the user's posture indicator.

As illustrated in FIG. 10, a method for controlling 300 a robotic walker 1 can advantageously include a step of calculating 340 a value of variation over time of a force applied to an electronic handle 200.

This step can be carried out by a method for controlling 40 a robotic walker 1 and more particularly by a processor 41 of said control module 40.

Particularly, such a variation value over time can correspond to a variation in the force applied during a predetermined time interval. The time interval is preferably less than 1 second, more preferably less than 0.5 seconds, even more preferably less than 0.2 seconds.

Thus, the method according to the invention allows following in real time the interactions of a user with a robotic walker 1 in order to determine their intention. This value can be calculated for an electronic handle 200 and preferably for the two electronic handles 200. Advantageously, the applied force whose time variation is calculated corresponds to a vertical component and a horizontal component of the applied force.

This calculated value can be used in a step of comparing 350 the value of the time variation in an applied force with a predetermined threshold value of the variation in the applied force.

Such a comparison allows generating an indicator of the user's intention. For example, the comparison step can lead to generating a binary value (e.g. yes/no).

Such an intention index can particularly correspond to an indicator of intention of displacement of the robotic walker 1 and therefore of the user.

This comparison step can also include the generation of an intention indicator in the form of an alphanumeric value or a numerical value. A digital value could for example correspond to a difference between the calculated value and the predetermined threshold value. An intention indicator value can be advantageously used in combination with other values during the generation of a control instruction.

Thus, the method according to the invention can advantageously better characterize the intention of a user to move. It has particularly been shown that the joint use of a detection threshold based on an applied force value, preferably a vertical and horizontal component value, coupled with a detection threshold based on a value of the applied force variation allows for better monitoring results and an increase in the specificity of the monitoring of the displacement of the robotic walker 1.

Furthermore, a method for controlling 300 a robotic walker 1 can also include a step of determining a value of the distance between the trunk of a user of the robotic walker 1 and a distance sensor.

For example, a distance sensor can determine the distance between the user and said distance sensor. This value of the distance from the user or an index of his position resulting from such a distance value can be advantageously used in combination with other values during the generation of a control instruction.

This step can be carried out by a control module 40 and more particularly a processor 41 configured to determine the distance separating a user from a distance sensor positioned on the robotic walker 1, based on the data provided by said distance sensor.

Furthermore, a method for controlling 300 a robotic walker 1 can also include a step of generating 360 a control instruction to at least one of the displacement motors 20. As has been discussed, this step of generating a control instruction can be carried out based on the measured value of the force applied to an electronic handle or on a posture index value. Particularly, the control instruction can be a function of the comparison of at least one applied force value with a predetermined threshold value of the applied force.

Advantageously, the generation 360 of a control instruction can also take into account other parameters. Preferably, it takes into account the measured value of the force applied to an electronic handle 200 or the posture index value in combination with the time variation value of a force applied to an electronic handle or the intention index value.

Furthermore, the generation 360 of a control instruction can also take into account the value of the index of the position or the measured value of the distance of the user relative to the distance sensor.

This step can be carried out by a module for controlling 40 a robotic walker 1 and more particularly by a processor 41 of said control module.

1. A robotic walker including a chassis having a front portion and a rear portion, a pair of wheels being arranged to support the rear portion of the chassis, and at least one wheel being arranged to support the front portion of the chassis,
at least one of the wheels being coupled to a displacement motor, said robotic walker including a control module configured to control the displacement motor(s),
the control module being configured to:
Determine, at a given moment, an indicator of an involuntary movement of a user of the robotic walker that could lead to a fall of said user, the indicator of an involuntary movement of a user of the robotic walker being determined based on values generated by one or several sensor(s) selected among: a sensor integrated into an electronic handle, a sensor configured to measure displacement of a said wheel, a distance sensor configured to measure a distance between the user and the robotic walker or a sensor positioned on the user of the robotic walker;
Identify a previous position, at the given moment, of at least one of the wheels, preferably at least two wheels;
Transmit to the displacement motor(s) a command to stop the robotic walker; and
Transmit to the displacement motor(s) a command to move the robotic walker so that it finds the previous position at the identified given moment.

2. The robotic walker according to claim 1, wherein the command to move the robotic walker includes a predetermined duration of return to the previous position at the identified given moment allowing the control module to determine a speed of displacement of the wheels.

3. The robotic walker according to claim 1, wherein the command to stop the robotic walker includes a predetermined immobilization duration allowing the control module to determine a speed of displacement of the wheels before they stop.

4. The robotic walker according to claim 1, wherein the previous position at the given moment corresponds to the position of the wheel(s) at least ten milliseconds before the given moment.

5. The robotic walker according to claim 1, wherein the indicator of an involuntary movement of a user of the robotic walker is determined based on values generated by a sensor integrated into an electronic handle and a distance sensor configured to measure the distance between the user and the robotic walker.

6. The robotic walker according to claim 1, wherein the indicator of an involuntary movement of a user of the robotic walker is determined over a predetermined time interval.

7. The robotic walker according to claim 6, wherein the indicator of an involuntary movement of a user of the robotic walker is determined over a time interval comprised between 0.01 ms and 50 ms.

8. The robotic walker according to claim 1, wherein the indicator of an involuntary movement of a user of the robotic walker is determined from a comparison between a calculated value of a variation in a speed of at least one said wheel and a threshold value of the variation in the speed of at least one said wheel.

9. The robotic walker according to claim 1, comprising at least one electronic handle including a sensor operatively coupled to the control module and configured to determine a force of interaction between a hand of the user and the robotic walker, wherein the indicator of an involuntary movement is determined from said force of interaction.

10. The robotic walker according to claim 1, comprising at least one distance sensor configured to measure a value of the distance between the user and the robotic walker, the control module being further configured to identify the indicator of an involuntary movement of a user of the robotic walker that could lead to a fall of said user based on the distance value, preferably when the measured distance value is not comprised between predetermined bounds.

11. The robotic walker according to claim 1, comprising at least one sensor integrated into an electronic handle configured to allow determination of a value of force of interaction between a hand of the user and the robotic walker, the control module being further configured to identify the indicator of an involuntary movement of a user of the robotic walker that could lead to a fall of said user, based on the determined value of the force of interaction, preferably when the determined force value is greater than a predetermined threshold value.

12. The robotic walker according to claim 1, further comprising:
a data memory, coupled to the control module, configured to store a predetermined value of a force multiplier coefficient and a predetermined value of a walking assistance adjustment coefficient;
two electronic handles each including at least one sensor operatively coupled to the control module, each said sensor being configured to generate data of the force of interaction between a hand of the user and the robotic walker;
at least one displacement sensor configured to measure displacement data of the walking assistance robotic walker;
the control module being further configured to:
Determine a value of the force of interaction between a hand of the user and the robotic walker for each of the electronic handles based on the data generated by each of the sensors of the electronic handles;
Determine a value of the speed of displacement of the robotic walker based on measured displacement data;
Calculate, for each of the motorized wheels, an increment value based on:
values of the force of interaction between a hand of the user and the robotic walker corrected with the predetermined value of the force multiplier coefficient, and
the value of the speed of displacement of the robotic walker corrected by the predetermined value of the walking assistance adjustment coefficient.

13. The robotic walker according to claim 1, wherein the electronic handle is arranged so as to allow measurement of at least two components of a force being applied thereto, said electronic handle comprising:
a first photoelectric cell, said first photoelectric cell including a first diode configured to emit a first light beam and a first receiver arranged to receive said first light beam, said first photoelectric cell being configured to generate a current proportional to an amount of photons received by the first receiver, and
a first obturation element configured, depending on its position relative to the first photoelectric cell, of modifying the amount of photons received by the first receiver,
the first photoelectric cell and the first obturation element being arranged such that the force applied to the electronic handle causes a modification of the amount of photons received by the first receiver, said modification being proportional to a first component of the force that has been applied to the electronic handle,
a second photoelectric cell including a second diode configured to emit a second light beam and a second receiver arranged to receive said second light beam, said second photoelectric cell being configured to generate a current proportional to an amount of photons received by the second receiver,
a second obturation element configured, depending on its position relative to the second photoelectric cell, of modifying the amount of photons received by the second receiver,
the second photoelectric cell and the second obturation element being arranged such that the force applied to the electronic handle causes a modification of the amount of photons received by the second receiver, said modification being proportional to a second component of the force that has been applied to the electronic handle, said electronic handle being configured to control said motor based on the values of the two calculated force components.

14. The robotic walker according to claim 13, wherein the electronic handle includes a central part and an external casing, the electronic handle being arranged such that a force, adapted to the command of the walking assistance apparatus, applied to the electronic handle is able to move at least partly the central part or the external casing, preferably able to move at least partly the central part.

15. The robotic walker according to claim 14, wherein the first photoelectric cell and/or the first obturation element and the second photoelectric cell and/or the second obturation element are fixed on the central part.

16. The robotic walker according to claim 14, wherein the central part comprises at least one embedded beam comprising an embedded end and a free end, said free end having a degree of mobility facilitating a displacement of said free end along a direction of the second component of the applied force.

17. A system for monitoring the displacement of a walker comprising:
the robotic walker according to claim 1, said robotic walker further comprising a beacon associated with the walker,
at least one independent beacon configured to reflect or emit a signal,
the robotic walker being configured to actuate braking when a distance between the beacon associated with the walker and the independent beacon is less than a predetermined threshold value.

18. A method for preventing a fall of a user from a robotic walker, said prevention method including the following steps implemented by a control module:
determining, at a given moment, an indicator of an involuntary movement of a user of the robotic walker that could lead to a fall of said user;
identifying a previous position, at the given moment, of at least one of the wheels, preferably at least two wheels;
transmitting to a displacement motor an instruction to immobilize the robotic walker; and
transmitting to the displacement motor an instruction to move the robotic walker so that it finds the previous position, at the identified given moment, of the at least one of the wheels.
